(19) United States
(12) Patent Application Publication
(10) Pub. No.: US 2020/0401969 A1
(43) Pub. Date: Dec. 24, 2020

(54) WEB-BASED CHEMICAL EXCHANGE SYSTEM AND METHOD

(71) Applicant: Echo Chemical Exchange Inc., Lake Forest Park, WA (US)

(72) Inventors: Richard Scott Barrows, Lake Forest Park, US (US); Austin Arthur Britts, Bend, OR (US); Kevin James Fuller, Bend, OR (US); Michal Unzeitig, Ostrava (CZ)

(73) Assignee: Echo Chemical Exchange, Lake Forest Park, WA (US)

(21) Appl. No.: 16/971,272

(22) PCT Filed: Feb. 25, 2019
(86) PCT No.: PCT/US2019/019432

§ 371 Date: Aug. 19, 2020

Related U.S. Application Data
(60) Provisional application No. 62/634,689, filed on Feb. 23, 2018.
(60) Provisional application No. 62/676,060, filed on May 24, 2018.

(51) Int. Cl. G06Q 10/06; G06Q 10/08; G06Q 30/06; G06Q 10/10; G06F 16/17; G06F 16/903

(52) U.S. Cl. CPC G06Q 10/06315; G06Q 10/0832; G06Q 30/0623; G06Q 10/08355; G06F 16/90344; G06Q 30/0635; G06Q 10/10; G06Q 10/087; G06F 16/1734; G06Q 30/0607

(57) ABSTRACT

A web based purchasing system and method for chemical purchases in industrial quantities. An exchange platform allows sellers to post chemicals for sale. Sellers may choose criteria defining the geographical area of sale for their goods, and the like. Purchasers seeking goods search the exchange for chemicals that they need, while being able to input various criteria associated with their purchase, such as quantity, purity, and the like. In an alternative example financial service that are desirable to facilitate a sale or transfer of chemicals is also provided on the exchange.

### TECHNICAL FIELD

This invention relates generally to product distribution, and more specifically the purchase and distribution of chemicals.

### BACKGROUND ART

Distribution is the process of making a product or service available for a consumer or business user who needs it. Distribution can be done directly by the producer or service provider, or using indirect channels with distributors or other intermediaries. Although distribution, as a concept, is relatively simple, in practice distribution may involve a range of activities including: logistics, transportation, warehousing, storage, inventory management as well as channel management including selection of channel members and rewarding distributors. There are typically three approaches to distribution: mass, selective or exclusive distribution.

in selective distribution a manufacturer may choose to restrict the number of outlets handling a product. For example, a manufacturer of premium electronics may choose to deal with department stores and independent outlets that can provide added value service level required to support the product. Some of the brands may insist that sales staff are trained to use the product range. Or, the manufacturer may only allow trained technicians to sell their products.

A firm can design any number of channels they require to reach customers efficiently and effectively. Channels can be distinguished by the number of intermediaries between producer and consumer. If there are no intermediaries then this is known as a zero-level distribution system or direct marketing. A level one (sometimes called one-tier) channel has a single intermediary. A level two (alternatively a two-tier) channel has two intermediaries, and so on. This flow is typically represented as being manufacturer to retailer to consumer, but may involve other types of intermediaries. In practice, distribution systems for perishable goods tend to be shorter—direct or single intermediary, because of the need to reduce the time a product spends in transit or In storage. In other cases, distribution systems can become quite complex involving many levels and different types of intermediaries.

The logistics of implementing distribution channels can be complex and varied. Logistics is generally the detailed organization and implementation of a complex operation, and in particular it is the management of the flow of things between the point of origin and the point of consumption in order to meet requirements of customers or corporations.

Logistics management is the part of supply chain management that plans, implements, and controls the efficient, effective forward, and reverse flow and storage of goods, services, and related information between the point of origin and the point of consumption in order to meet customer's requirements. The complexity of logistics can be modeled, analyzed, visualized, and optimized by dedicated simulation software. The minimization of the use of resources is a common motivation in all logistics fields.

Another current trend is the increased use of the internet in commerce. In the past dedicated data terminals and connections might be used in offices and warehouses to put buyers and sellers in communication with each other. This state of affairs tended to limit the availability of a distribution network to buyers and sellers of goods.

in distribution networks the logistics of carrying out the ordering and distribution of particular products in a given class of goods can be complex. Also, optimization of such efforts for efficiency and cost effectiveness is an ongoing and evolving effort. Accordingly in chemical ordering and distribution and logistics a web based chemical exchange system and method would be desirable.

### DISCLOSURE OF THE INVENTION

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

This invention of a web-based chemical exchange system and method relates generally to a product distribution, and more specifically the distribution of chemicals. Specific details of certain examples of the web-based chemical exchange system and method are set forth in the following description and in the figures to provide a thorough understanding of such examples. The present invention may have additional examples, may be practiced without one or more of the details described for any particular described example, or may have any detail described for one particular example practiced with any other detail described for another example. Many of the attendant features will be more readily appreciated as the same becomes better understood by reference to the following detailed description considered in connection with the accompanying drawings.

### BRIEF DESCRIPTION OF DRAWINGS

The present description will be better understood from the following detailed description read in light of the accompanying drawings, wherein:

FIG. 1 is a block diagram showing conventional distribution networks.

FIG. 2 is a block diagram showing a new web-based chemical exchange system and method (“Exchange”).

FIG. 3 is a flow diagram showing the chemical exchange subsystem component 214 of a new chemical distribution network including consolidated purchasing, custom broadcast controls, product mapping, and additional ancillary systems.

FIG. 4 is a process flow diagram showing product mapping 302.

FIG. 5 is an product mapping example showing synonyms 502 that map to 2-Propanol, CAS Registry Number: 67-63-0, 504.

FIG. 6 is a block diagram showing the custom broadcast controls 304.

FIG. 7 is a screenshot showing an example of custom pricing by region in the custom broadcast controls for a seller.

FIG. 8 is a screenshot showing an example of broadcast and un-broadcast control of the custom broadcast controls.

FIG. 9 is a screenshot showing an example of selection and de-selection of custom broadcast controls for a purchaser's list of desired chemicals.

FIG. 10 is a process flow diagram showing a process of implementing custom broadcast controls.

FIG. 11 is a process flow diagram of broadcast control center principals.

FIG. 12 is a block diagram showing consolidated purchasing (shipping) 306 components.

FIG. 13 is a screenshot showing an example of consolidated purchasing showing a first process of filling a truck, shipping container, rail car or the like.

FIG. 14 is a screenshot showing an example of consolidated purchasing showing a subsequent process step in the process of filling a truck, shipping container, rail car or the like.

FIG. 15 is a process flow diagram showing a first example of consolidated shipping.

FIG. 16 is a process flow diagram showing a second example of consolidated shipping.

FIG. 17 is a flow diagram showing a process of setting up and using the new web-based chemical exchange.

FIG. 18 is a screen shot showing a seller's importation of product offerings on the new web-based chemical exchange.

FIG. 19 is a screen shot showing a seller's set up of product offering conditions on the new web-based chemical exchange 1308.

FIG. 20 is a screen shot showing a seller's set up of product pricing on the new web-based chemical exchange.

FIG. 21 is a screen shot showing a buyer's results of searching the new web-based chemical exchange.

FIG. 22 is a screen shot showing a buyer' completion of product selection on the new web-based chemical exchange.

FIG. 23 is a screen shot showing a buyer's review of hazmat information.

FIG. 24 is a screen shot showing a buyer' final review of a product order on the new web-based chemical exchange.

FIG. 25 is a screen shot showing a buyer' completion of a product order on the new web-based chemical exchange.

FIGS. 26 and 27 show a process flow diagram for an example of order flow.

FIG. 28 is an example of a computer network system upon which the new chemical distribution network (“Exchange”) may be implemented.

FIG. 29 is an example of a computing system upon which the new chemical distribution network may be implemented.

Like reference numerals are used to designate like parts in the accompanying drawings.

### BEST MODE FOR CARRYING OUT THE INVENTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

The examples below describe a new chemical distribution network system and method (“Exchange”). Although the present examples are described and illustrated herein as being implemented in a chemical purchasing system, the system described is provided as an example and not a limitation. As those skilled in the art will appreciate, the present examples are suitable for application in a variety of different types of goods and services purchasing systems.

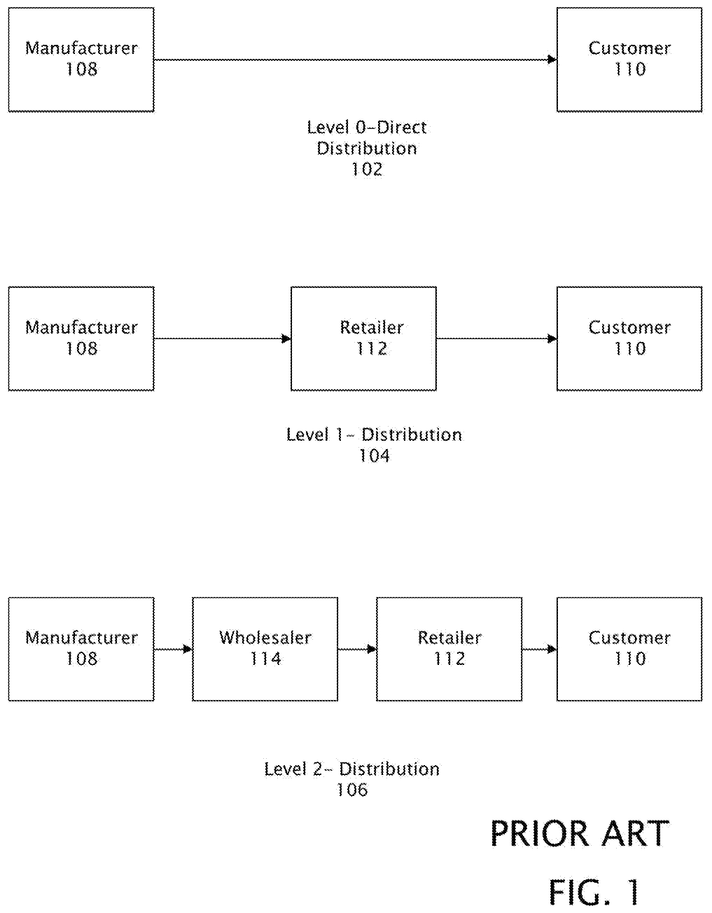

FIG. 1 is a block diagram showing conventional distribution networks. Distribution channels can take on many forms. In a zero level or direct distribution system, manufacturers deal directly with customers. In a level one distribution system a retailer is disposed between the manufacturer and customer. In a level 3 distribution system, a wholesaler may be present between the manufacturer and the retailer. Distribution systems can take on further levels of complexity, and the distribution of chemicals in the typical market place tends to be complex.

Today's chemical industry supply chain tends to be one of the most fragmented, inefficient and archaic of its kind. Chemical buyers or manufacturers (for example paint makers, injection molders, soap makers, cosmetic companies, smelters, and the like) are typically limited to the supply held by their local distributors. Finding out what is available takes a number of calls and days of waiting for an answer by the buyer. Chemical manufacturers are also often hamstrung by the breadth of the distributors (For example there might be a number of sources, however the distributor may only have access to a small number of them) while also sacrificing margin for their services. Both distributors and manufacturers tend to pay increased prices because of delayed information and limited options. A system and method that allows sellers of chemicals and buyers to efficiently find needed stock and arrange for its purchase is accordingly desirable.

Described below is a system to aid in chemical shipping. Efficient transport keeps shipping costs down and further increases the utility of the exchange. The system allows space available on a delivery vehicle to be matched to chemicals purchased that may have delivery destinations on the way or otherwise close to the original destination, or destinations of the delivery vehicle. The system uniquely takes into consideration the origination and destinations of the chemicals being shipped to generate an efficient delivery route, and also generates all of the needed paperwork needed for shipping which may include printing shipping instructions, bills of lading, shipping labels, HAZ MAT labeling or the like.

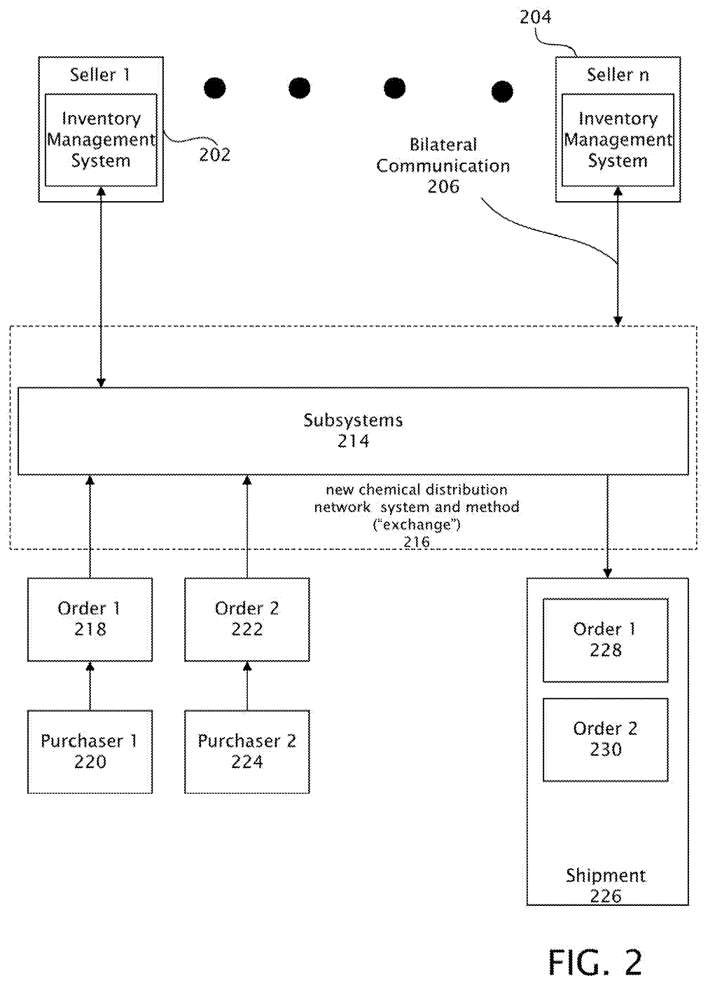

FIG. 2 is a block diagram showing a new web-based chemical exchange system and method (“Exchange”). The new web-based chemical exchange system and method described herein is typically a business to business (“B2B”)platform uniquely implemented for the Chemical Industry. The web-based chemical exchange system and method provides private networks with customizable broadcast controls that allow distributors to protect relationships and pricing all while adhering to responsible distribution practices.

The new chemical distribution network system and method may use FTP and API technology to create a bi-lateral communication between a seller's inventory in their ERP (or any other inventory management system) and the new chemical distribution network system and method (“Exchange”). As inventory is entered and priced in a seller's ERP, that data (quantity, price, packaging, etc.) may be relayed in to the exchange for potential buyers around the world to view, compare and purchase.

What makes the Exchange innovative is it requires little change in the industry's day to day operations as it accepts real time inventory feeds via FTP or API. The FTP options resides on the user's server and automatically pulls .csv files (or equivalent) on a timed schedule (or a schedule based on other desirable characteristics, such as events) to communicate inventory and price changes. The API connection option tends to be even stronger where it connects real time with the Exchange system. Advantageously both typically require no further work from the supplier, except for them choosing what inventory to broadcast.

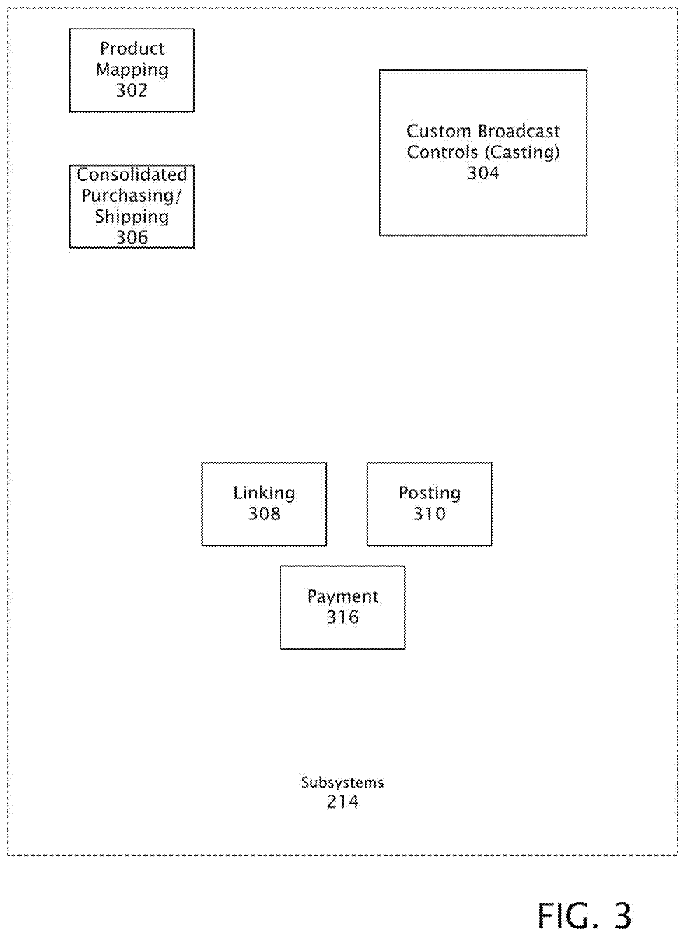

FIG. 3 is a flow diagram showing the chemical exchange subsystem component 214 of a new chemical distribution network including consolidated purchasing, custom broadcast controls, product mapping, and additional ancillary systems. The new chemical distribution network system and method of the present invention may be of advantage in improving current chemical distribution practices. The new chemical distribution network is the World's first Global Chemical Exchange. The new chemical distribution network provides a web-based portal that can accept real-time inventory feeds via FTP (File Transfer Protocol), API (Application Protocol Interface) connections, or the like from the largest ERP (Enterprise Resource Planning) systems (or the like) tending to create a unified single marketplace for the chemical industry to use. No longer will a buyer need to wait an exemplary three days for a call back on inventory availability or will a manufacturer be limited to the reach of his distributors. The new chemical distribution network system and method creates a 24/7/365 real-time connection to the world's chemical inventory.

The overall system and method of purchasing chemicals is termed the new chemical distribution network or simply the Exchange. In the Exchange environment various sub systems and methods may cooperatively function to facilitate the purchase of chemicals or the like. The new chemical distribution network is typically web-based including custom broadcast controls 304, product mapping 302, consolidated purchasing 306 and other subsystems 308, 310, 312, 314, 316 described herein. The systems and methods described above may operate cooperatively on conventional computer hardware and networking infrastructure (including the internet, or equivalent), which may include custom built hardware to provide security, limited access or the like.

Custom Broadcast Controls 304

Custom Broadcast Controls 304 allow a seller to pick and choose by which state, country, region, branch or company can view inventory on a global or per product offer basis. It also allows the seller to do custom pricing per product, choose to list anonymously, set payment terms, and also international Commercial Terms for the pricing type they view. International Commercial Terms (“IncoTerms”) are a series of pre-defined commercial terms published by the International Chamber of Commerce (“ICC”) relating to international commercial law.

Product Mapping 302

Product Mapping 302 tends to remove the ambiguity in names for the same chemical substance. There are over 64,000,000 types of chemicals, and each distributor and supplier can often have 100 different ways of naming that chemical internally by product name and number, and also each of the 64,000,000 plus chemicals can have up to 50 different synonyms. This can create a challenge for allowing users to enter a marketplace to search and view inventory in an easy and organized manner. The web-based chemical exchange system and method maps those internal product names to globally recognized CAS Index Names and Numbers so users can easily search and find the product they need in the marketplace.

Consolidated Purchasing 306

Consolidated Purchasing 306 can reduce or eliminate the current pain point in that large suppliers do not want to send out shipments smaller than full truck loads from their production plants. However, many times a distributor does not want to or need to buy that large of order. They are then stuck waiting sometimes weeks till them have enough orders to create a full truck load. Then the order can be released from the plant. The web-based chemical exchange system and method allows multiple distributors to pool together to fill trucks up from a single plant, thus helping the truck to get out quicker, and allowing the buyers to buy less than full truck load orders. As such a system can encourage the sellers to still provide discounted full truck load pricing. Next the full truckload is taken to a distribution center where the pallets and or drums are split out. All of this is blind for the buyers as they do not know who the other companies that are buying on that truck. Physical Bills of Ladings may be created by the web-based chemical exchange system and method for the original full truck load and also for the dispersed shipments from the distribution center.

Linking Subsystem 308

The linking subsystem 308 may be implemented in a software platform to use automated technologies such as, but not limited to, FTP and API transfers of information to a centralized marketplace for the chemical industry. As a first example of a linking system information may be taken from an ERP via FTP (or equivalent) and sent to the Exchange (one direction communication into The exchange). In a second example the information may be taken via API (or equivalent) which allows bi-lateral communication between the Exchange and the ERP (or any other source that holds information). Information available for transfer includes, but is not limited to, chemical name, quantity, C of A documents, MSDS documents, price, condition, packaging, Unit of Measure, and more.

Posting Subsystem 310

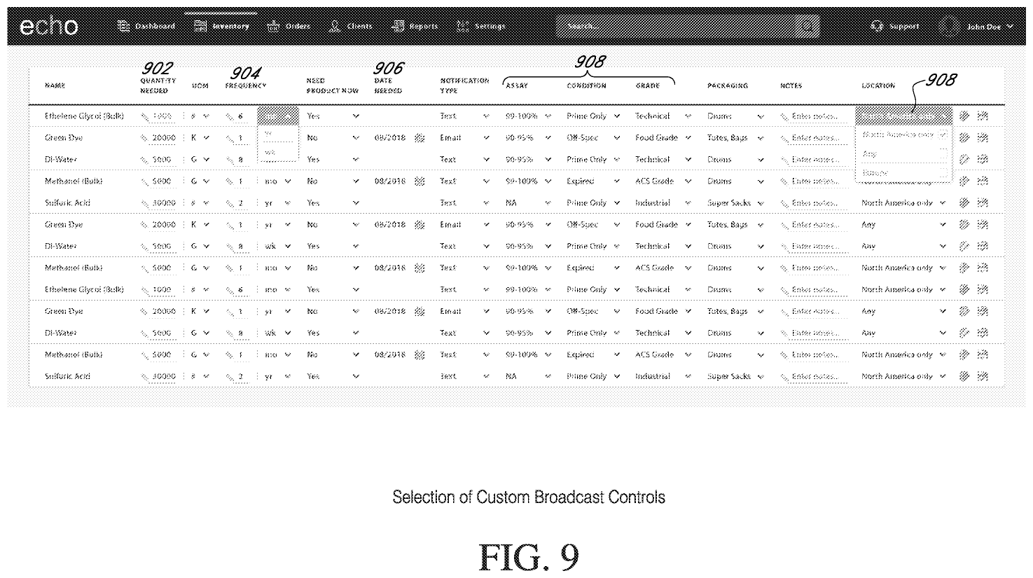

Posting allows users to bring in chemical names that they use and purchase and then add attributes to eventual posts out to the chemical community. Those companies searching can see the posts and send back bids to fulfill the need inventory need (FIG. 9 shows an Exemplary GUI shown providing exemplary information provided to a potential buyer). In addition to the general process of posting materials for sale and purchasing the materials, the Exchange provides numerous subsystems and methods to further tailor how materials are offered, and may be purchased.

in the posting subsystem process, first the purchaser's ERP is queried, and information about the desired chemicals for purchase is input into the Exchange. The purchaser may edit the information in the exchange and then broadcast the resulting listing of chemicals desired. Sellers may view the listing of chemicals desired on the Exchange. Sellers may send offers to the buyer, and the buyer may accept or decline the offer.

in the posting subsystem:

1) The information resides on a potential buyer's ERP and it pertains to what chemicals that user purchases.

2) That information is sent via FTP or API.

3) That information is sent to Exchange and is input into the buyer's Exchange account.

4) The buyer then adds or edits any pertinent information and then chooses to broadcast it out to be viewed by other users.

5) That information is viewed by users that could potentially have product that would be attractive to that buyer/user.

6) Seller/user chooses to send an offer to the buyer/user.

7) The Buyer/user chooses to either accept or decline.

An optional capability is to produce a custom price sheet or book that a seller can share with their customers. Information in the exchange may be filtered to provide desired information for inclusion in the printed price book.

Printing a price list or book helps companies out in a number of ways in addition to how the Exchange already does: 1) Physical custom price sheet for Sales People that can be edited 24/7 compared to currently once a month and then printed out to view or distribute, 2) Physical custom price and product sheets for customers that can be viewed 24/7 compared to currently once a month and then printed out to view or distribute is desirable, 3) Ability for staff to print out and see current distribution maps of product pricing and holdings around the country or world is also allowed.

Payment Subsystem 316

in addition sellers typically would like to have immediate payment, and the buyer would typically like to delay payment for the more or less customary 30, 60, or 90 days (or the like). Accordingly, it would be desirable to incorporate a subsystem providing financial services into the Exchange system so that sellers are paid quickly and in which the buyer may arrange for terms of payment.

The Exchange payment subsystem is a unique method to promote liquid commerce in the chemical industry. Sellers currently have issues with collecting payment in a timely manner, and buyers are typically fighting for longer terms to send payments. What Exchange payment subsystem does is finances the transaction to provide payment to the seller faster while also letting the buyer choose what payment terms they would like (30, 60, 90 day terms, etc.) for a set financing cost.

First the Seller predefines acceptable payment terms (on confirmation, 30 day, 60 day, day, or the like) for transactions processed in the Exchange. When the buyer purchases from this Seller, the buyer can use their own funds to make payment in any conventional manner supported by the Exchange. Alternatively, the buyer may use a dedicated Exchange payment system as an intermediary.

In the Exchange payment system funds are transferred via the Exchange or a third party Financier, to the Exchange, and then via an ACH to the seller. The buyer, under the terms of their service agreement with the Exchange pays the Exchange an amount equal to that of the purchase plus applicable service fees, interest, or the like.

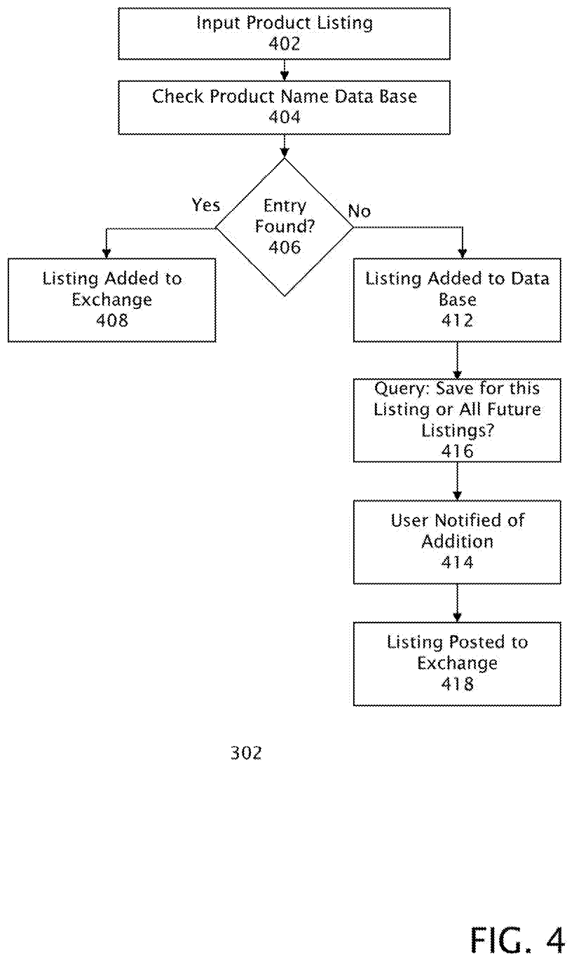

FIG. 4 is a flow diagram showing product mapping 302. One of the biggest challenges in the chemical industry is that there are over 64 million chemical types, and many of those have up to 50 unique synonyms per chemical. Furthermore each chemical company may create a unique trade name as well for that chemical product. The mapping sub system and method tends to alleviate this problem as many synonymous chemical names are resolved to a common listing used within the exchange to further aid in linking buyers and sellers.

First the system takes a product listing from a user's ERP (or any equivalent inventory source) and imports it into the exchange 402. The product listing is checked against the product name database 404, to see if there is a match 406. If yes, the listing is added to the Exchange 408. If no, the listing is added to the Mapping Data Base 412. Once identified the user clicks save including the user being queried if the chemical listing is to be saved for just this instance or for all future listings 416.

The user is notified of the addition typically by e-mail or other equivalent method, such as a message generated from within the Exchange 414. Finally the listing is posted to the Exchange 418. The following figure illustrates the multitude of names that a chemical may be known as and how such a variety of names may be resolved to a common listing for use in the Exchange.

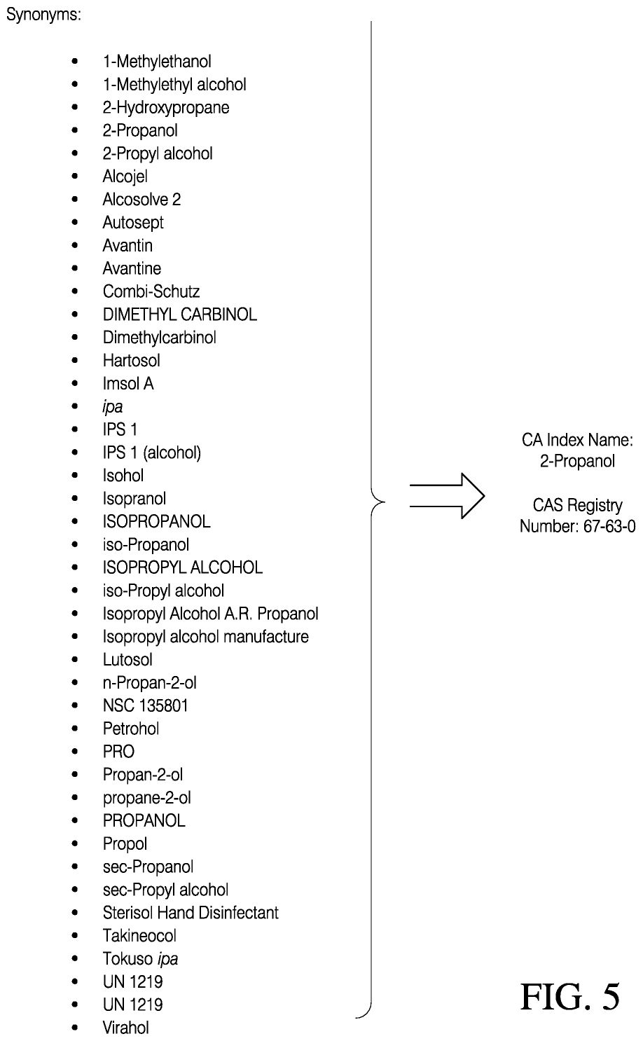

FIG. 5 is an example showing synonyms 502 that map to 2-Propano, CAS Registry Number: 67-63-0, 504. Tending to add to the problems in chemical distribution is the ambiguity in chemical names for chemicals listed on the exchange and the name a buyer may know the chemical by can cause mismatches and transactional inefficiencies. Accordingly a system and method for matching chemical names for an available chemical to a chemical desired to be purchased that may not necessarily match.

There can be a great deal of naming and identifying chemicals for a sales transaction. It can be costly in time and money if the wrong chemical is ordered. Accordingly a subsystem embedded in the exchange that tends to disambiguate, or otherwise helps to correctly match a customers desired to a product in stock is desirable. Also, if chemicals are listed on the Exchange under various names, than the mapping of the name of the chemical the customer is looking for to a name under which it is listed is advantageous to help match buyers with sellers. Accordingly the following describes the chemical name mapping process utilized in the exchange. First the terms, CAS Registry Number, CA Index Name, CA Index Synonym Name, Common Name. Product Name (formerly Chemical Name), and Trade Name will be further defined below, as they are utilized in the Exchange to disambiguate chemical names so that the substance bought is more likely what the buyer intended to purchase.

CAS Registry number: The CAS Registry number is the highest and most trusted identification of a chemical and is unambiguous in identification of the chemical. Every product offer is typically mapped to a CAS number. In this example below the CAS number is 67-63-0.

CA Index Name: This is the official name that is tied to the CAS number. It can sometimes be very long and be a mix of numbers and letters. Not something that you would easily reference or search for. In this example it is not too difficult as it is 2-Propanol.

CA Index Synonym Names: These are additional names that the CAS Registry number and CA Index Name may be referenced, or listed as. For 67-63-0, 2-Propanol a list of these CA Index Synonym Names is provided 502. Exchange will start with these synonymous terms and companies can suggest additional synonyms in as the system is used. In this example the entire list of names below Synonyms are CAS Index Synonym Names of 67-63-0 (2-Propanol). If an Exchange user types in 1-Methylethanol (the first synonym listed) in a search bar displayed in an Exchange user interface it should take them to 67-63-0 (2-Propano).

Common Name: the Exchange allows manually entry of what we want to designate as the common name, out of all possible synonyms. The Common Name may be displayed with the CAS number and CAS Index Name whenever possible. So in this example name disambiguation would yield “IPA, (2-Propanol) 67-63-0 (Common Name, CAS Index Name, CAS Registry number), or a listing in an equivalent alternative order. This combination is what we will use for a product listing in the Exchange (“PRODUCT”). Finally. A Common Name can also be a synonym but only one synonym can be the common name. Lastly, if a Common Name for this PRODUCT has not been entered or is otherwise not in the Exchange, then it would simply list as (2-Propanol) 67-63-0. An equivalent listing in an alternative example would be one in reverse order.

Product Name (formerly Chemical Name): This is the name (or numbers) that an Exchange user references the PRODUCT with in their own ERP system. In many instances this name can be different than both the CAS Index Name and any of the Synonyms. For this example let's say a user calls our exemplary substance IPA220. If IPA220 was imported into Exchange and had never been mapped to 2-Propanol then the name IPA220 would be sent to the Unmapped Queue in My Inventory. The user could search through possible matches until they found IPA (2-Propanol) 67-63-0 and then they would map it, or alternatively manually enter IPA, or (2-Propano), or 67-63-0 to match IPA220. The Exchange would then map IPA220 to IPA (2-Propanol) 67-63-0 every time moving forward. Product Name will only show in “My Inventory” (visible only to the person who uses this Product Name).

Trade Name: A Trade Name further distinguishes the Product Offer. Trade names can be a set database or alternatively users may add names. However, a set database tends to be preferred. ADDITIONAL NOTE: If an Exchange user imports a list of Product Offers and the system sees that the product has not been mapped for but it does match a synonym that the system recognizes then it still goes to the Unmapped Section, maps it to the PRODUCT, but instead of it having a button that says MAP, it has two that either says CONFIRM or RE-MAP.

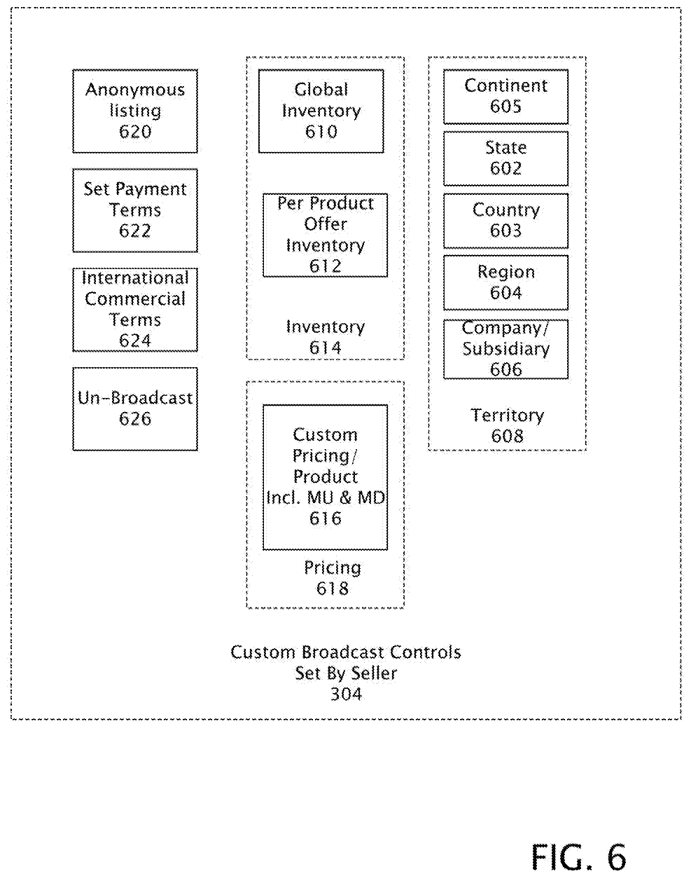

FIG. 6 is a block diagram showing details of the custom broadcast controls 304. Custom Broadcast Controls allow a seller to pick and choose by which state, country, region, branch or company can view inventory on a global or per product offer basis. Typically a user types in a company name, or the user selects the company name. Then the user saves the entry. The seller's inventory is no longer able to be viewed by the company selected. The Exchange also allows users to assign custom pricing per product, choose to list anonymously, set payment terms, and also IncoTerms for the pricing type they view.

Territory or Casting Subsystem 608

Casting, or territory 608 is an optional subsystem which allows users to pick and choose which states 602, countries 603 and regions 604 (or generally territory 608) which their inventory will or will not be broadcasted to. It also allows users to pick and choose pricing 616 such as custom % mark up/down (or other regionally applicable information to be applied) to each state, country, region and companies 616 and save those settings.

In territory election 608, typically a user clicks on a state, region, or country on a map GUI. If clicking changes the mapped area's color to change to an exemplary blue then the selected region may be considered Un-broadcast. Alternatively, of clicking changes it to an exemplary green then the exemplary region is broadcast.

Pricing 618

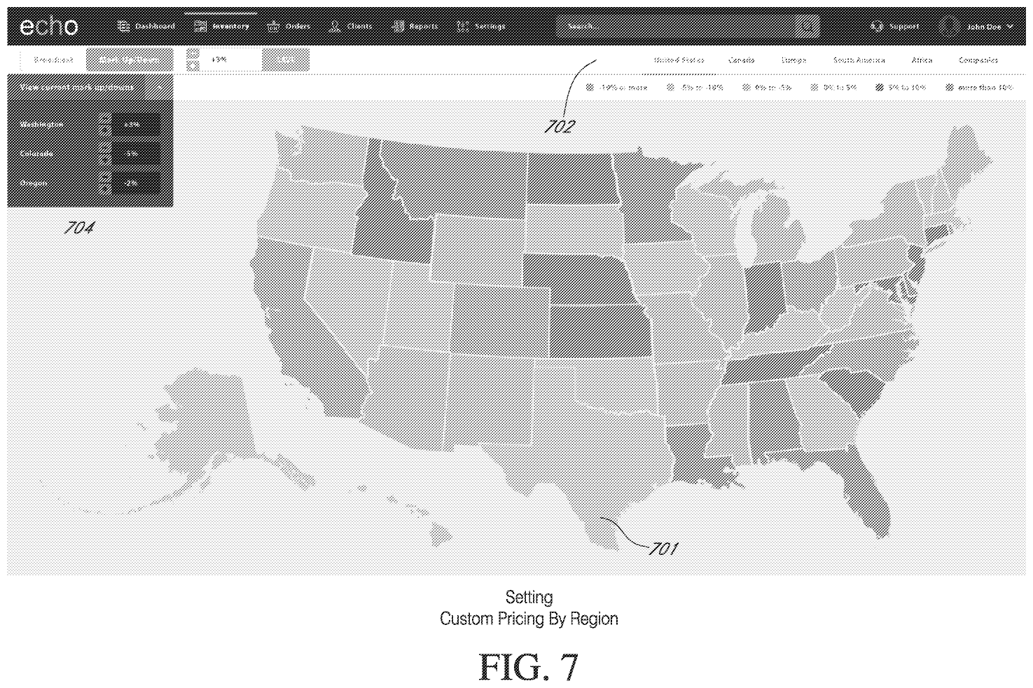

Included in the Casting Subsystem is a pricing module 618 having an optional Markup/Down subsystem 616 that allows a seller to set a markup or markdown by geographical area, or otherwise provide custom pricing of products. The GUI (shown if FIG. 7) is similar to that of the casting subsystem as a map is generated in which a user may select a markup/markdown for a region previously selected-typically from a drop down menu or other selection structure provided, as well as one in which the markup or markdown may be entered manually.

On a map or regional graphical interface a user typically clicks on a state or region, enters the mark up or mark down percentage, and saves the entry, inventory for that particular state or region is then marked up or down by the amount entered, if any.

Un-Broadcast 626

In un-broadcast 626 a seller may set up his offering so that selected other criteria may also be selectively shown to a potential buyer. For example a seller may only wish to display information to certain buyers (or alternatively exclude certain buyers). In further alternative examples more detail in presenting sale information to a buyer is contemplated. For example a certain buyer, or buyers, may be only selectively offered certain materials, certain grades or the like rather than being wholly excluded.

The un-broadcast process may be implemented through an exemplary screen interface in which the seller inputs a company name into an exclusion list. Alternatively a list of purchasers may be provide with check off boxes for purchasers to be excluded, or other selective information to be shown or not shown to a prospective purchaser.

The broadcast controls 304 may also include functionalities to provide anonymous listings 620, set payment terms 622, allow for international commercial terms 624, and inventory settings 614 that may include global inventory offerings 610, and per product offers of inventory 612.

FIG. 7 is a screenshot showing an example of custom pricing by region in the custom broadcast controls for a seller. Here a map 701 is displayed that is color coded 702 to show markups/downs. A user may set the markup/down via a drop down menu 704, or the like.

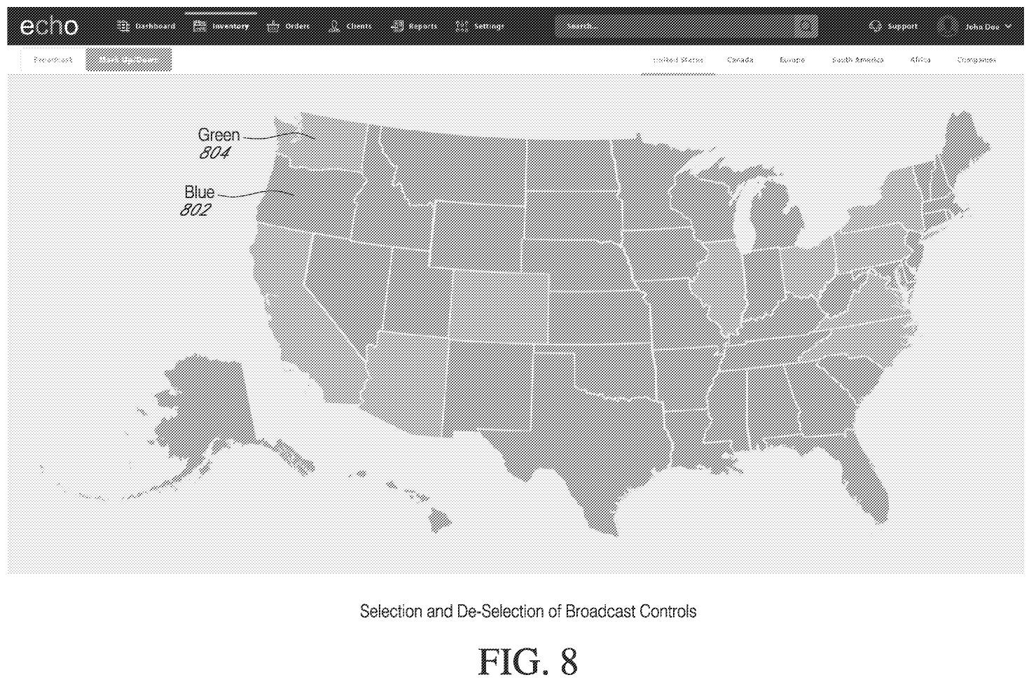

FIG. 8 is a screenshot showing an example of broadcast and un-broadcast control of the custom broadcast controls. Here a seller clicks on a state to toggle from broadcast to un-broadcast. Here exemplary green 804 states have been toggled to broadcast, while the exemplary blue 802 states have been toggled to un-broadcast.

FIG. 9 is a screenshot showing an example of selection and de-selection of custom broadcast controls for a purchaser's list of desired chemicals. Here a purchasers screen shows a list of chemicals desired by the purchaser. Through the exchange the purchaser may show various pertinent information such as the quantity 902, frequency of the purchase 904, dates needed 906, information regarding the purity or grade 908, and also any desired location from which the chemical is sought to be obtained from 910.

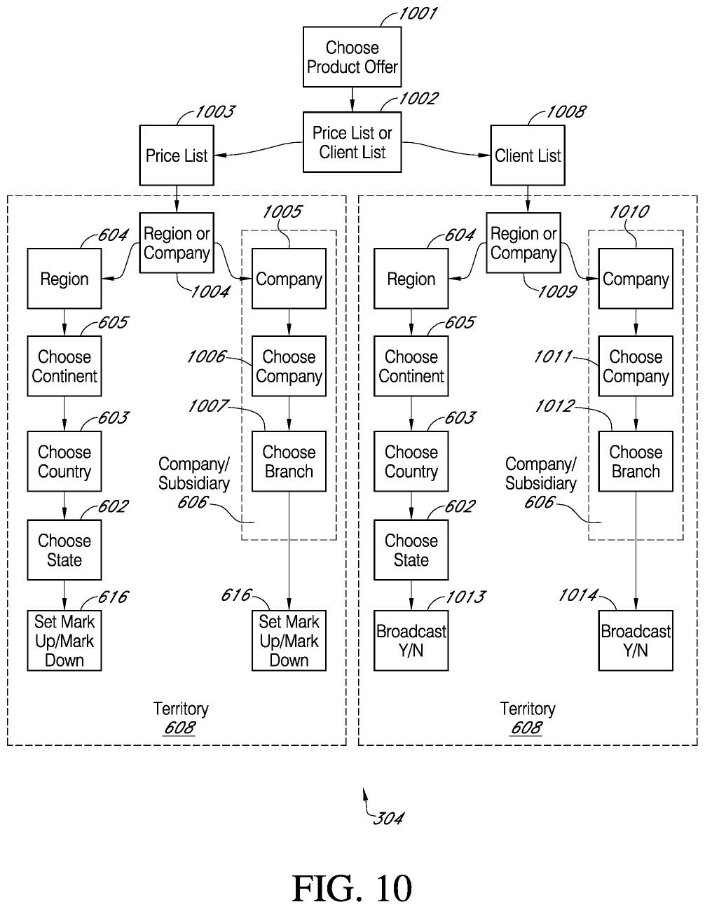

FIG. 10 is a process flow diagram showing a process of custom broadcast controls. First a product offer is chosen 1001. Nest a price list or client list is chosen 1002. If a price list is chosen 1003, then either a region or company is chosen 1004. In selecting a territory 608 either a region 604, continent 605, country 603 or state 602 may be selected, with a final mark up or mark down being selected 616.

If a company is chosen at 1004 then company or subsidiary information 606 may be entered, which may be for a company 1005, then choosing a company 1006, and then possibly choosing a branch 1007. Then finally a mark-up or mark down may be selected 616.

Returning to block 1002, if a client list is chosen 1008, then a territory 608 is defined for this selection. After choosing a client list 1008 either a region or country is entered 1009. For a region, region 604, a continent 605, a country 603, or a state 602 may be chosen.

Returning to block 1009, if a company or subsidiary 606 is chosen for entry then the company 1010, choosing the company 1011, and a branch 1012 may be selected, before deciding to broadcast 1014.

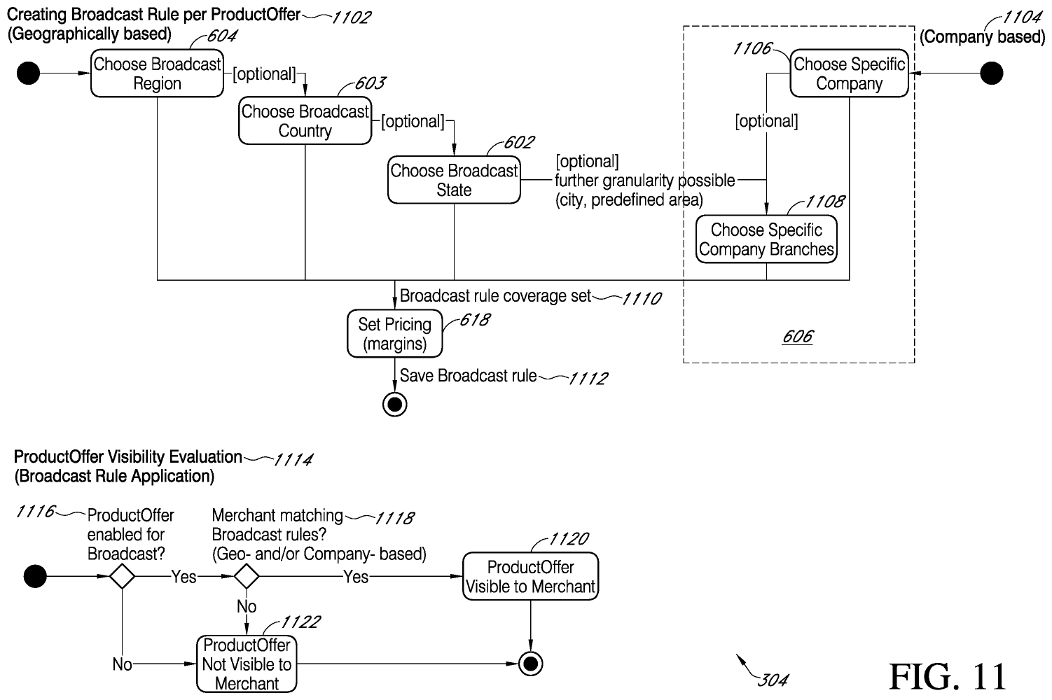

FIG. 11 is a process flow diagram of further details of broadcast controls 304. Product broadcasts can be geographically based 1102 or company based 1104. In a geographical based rule either regions 604, countries 603 or states 602 may be chosen. Optionally more than one may be selected. And finally in alternative examples further granularity is possible, such as exemplary cities, and predetermined areas.

in a company based 1104 approach broadcast criteria base on a corporate entity 606 may be utilized. A specific company 1106 may be chosen and or a specific company branch may be chosen 1108. And for either geographical or company based broadcast controls, once the broadcast rule coverage is set 1110, then pricing may be set including margins 618. Finally the broadcast rule is saved 1112.

The broadcast rule, once set may then be applied to offerings 1114. First it is determined if a product offer is enabled for broadcast 1116. If yes ti is next determined if there is a merchant matching the broadcast rules 1118. If yes the product offer is available to a merchant 1120 matching the preset criteria. Returning to block 1116 if the product offer is not enabled then the product offer is not visible to the merchant 1122. Likewise if there is no merchant matching the broadcast rules (geo, and or company based, then the product offer is not visible to the merchant.

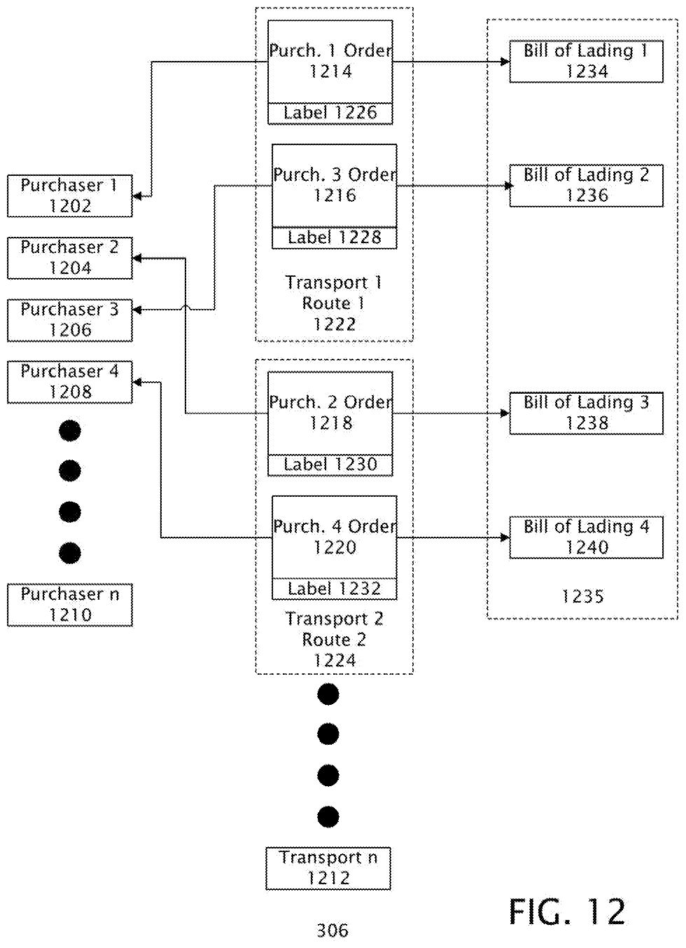

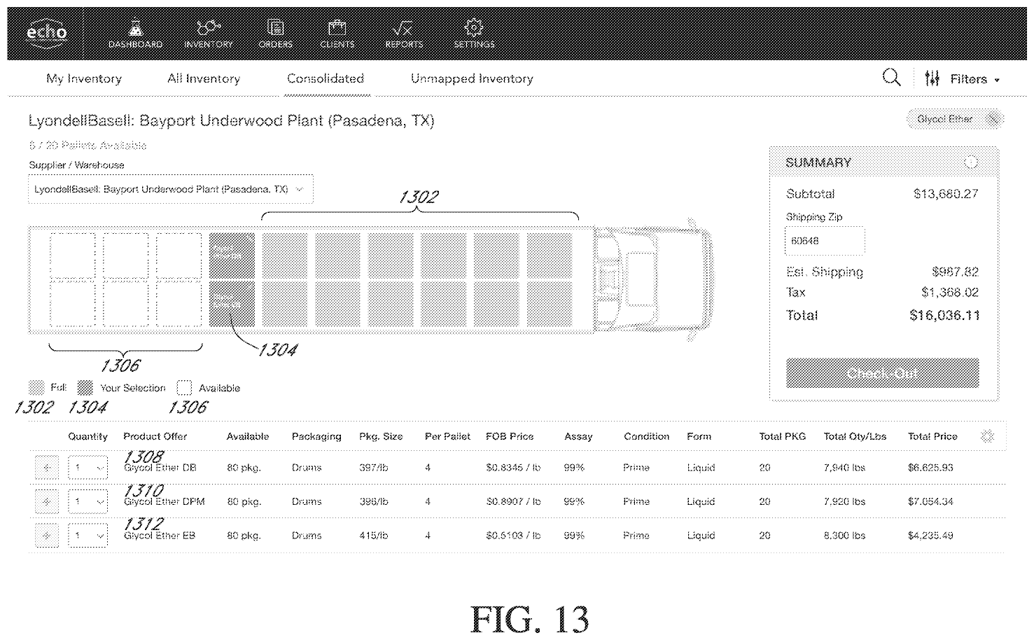

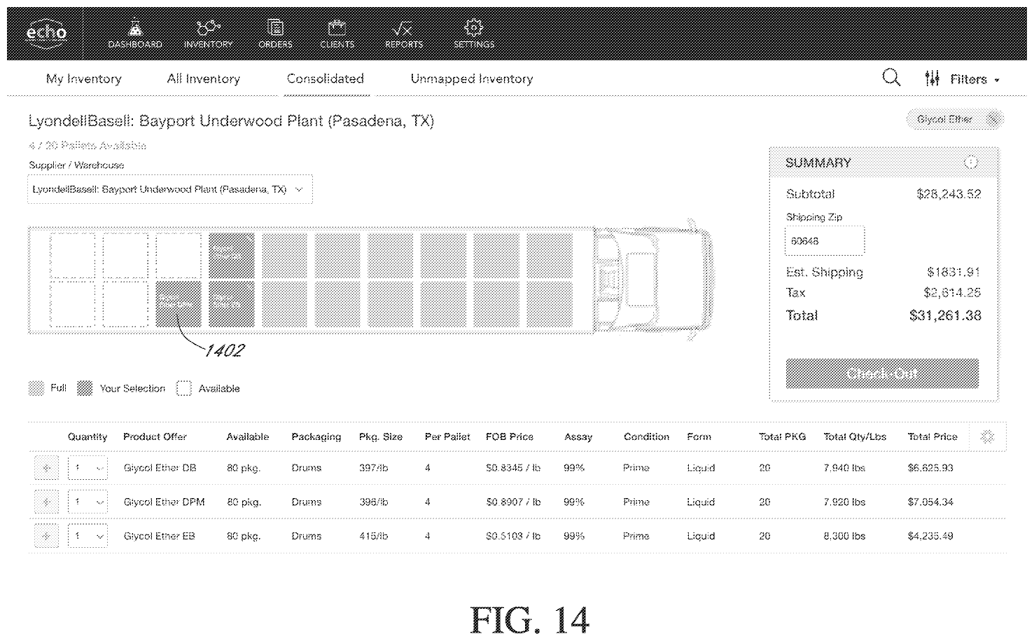

FIG. 12 is a block diagram showing consolidated purchasing (shipping) 306. The Exchange advantageously allows consolidation of chemical shipping to save costs and in general make the exchange more desirable to use. Chemicals from various suppliers can be matched to a delivery vehicle (truck, train, plane or the like) that has space available for delivery to one or more purchasers. The system takes into consideration the requirements of the chemicals being shipped, the space available, and the pick-up and drop off locations to optimize the pick-up and delivery of the chemicals. The system generates computer printed labels and shipping bills that may be needed by the truck driver and to otherwise facilitate delivery. The following description and screen shots in FIGS. 13-14 illustrate the consolidated shipping service

Consolidated Purchasing/Shipping Subsystem 306

A current pain point is that large suppliers do not want to send out shipments smaller than full truck loads from their production plants but many times a distributor does not want to or need to buy that large of order. They are then stuck waiting sometimes weeks till them have enough orders to create a full truck load. Then the order can be release from the plant. What the Exchange does is allows multiple distributors to pool together to fill trucks up from a single plant, thus helping the truck to get out quicker, it allows the buyers to buy less than full truck load orders, and it tends to encourage the sellers to continue to provide discounted full truck load pricing. The full truckload from the shipper is taken to a distribution center and the cargo is split out the pallets or drums. This process is not transparent to the buyers as they do not know who the other companies that are buying on that truck. Physical Bill of Ladings or print outs may be generated by the Exchange for the original full truck load, and also for the dispersed shipments from the distribution center in order to track the items.

The Exchange advantageously allows consolidation of chemical shipping to save costs and in general make the exchange more desirable to use. Chemicals from various suppliers 1214, 1216, 1218, 1220 can be matched to a delivery vehicle (truck, train, plane or the like) 1222, 1224 that has space available for delivery to one or more purchasers 1202, 1204, 1206, 1208, 1210. The system takes into consideration the requirements of the chemicals being shipped, the space available, and the pick-up and drop off locations to optimize the pick-up and delivery of the chemicals. The system generates computer printed labels 1226, 1228, 1230, 1232 (typically adhesive backed, bar coded, containing identifying indicia, and may be generated on site via a portable thermal printer or the like-alternatively RFID tags may be utilized), and shipping bills 1234, 1236, 1238, 1240 that may be needed by the truck driver and to otherwise facilitate delivery. The following description and screen shots illustrate the consolidated shipping service:

FIG. 13 is a screenshot showing an example of consolidated purchasing showing a first process of filling a truck, shipping container, rail car or the like. Here a partially full truck 1302 is filled with a customer's order 1304, and has remaining space available 1306 for another customer, or customers to fill. For this purchaser the Exchange screen shows all pertinent information regarding the shipment utilizing an easy to visualize representation of the shipping vehicle, as well as the specifics regarding the chemicals purchased here including that three shipping units of Glycol Ether type chemical 1308, 1310, 1312 make up the order, and two have been placed on the truck by a user clicking or otherwise selecting an open spot on the truck.

FIG. 14 is a screenshot showing an example of consolidated purchasing showing a subsequent process step in the process of filling a truck, shipping container, rail car or the like. Here the final component of the order has been placed on the truck 1402 completing the shipping placement for this order. The user has the ability to place an order where desired on the truck, and the Exchange may determine using preset criteria if the entire truck must be filled before dispatching it or if partial filling, and to what extent is acceptable. The following is an example of how the consolidated purchasing component of the Exchange functions.

Example of Consolidated Purchasing

Problem: Large Suppliers such as DOW only want to sell full truckloads (“FTL's”) at a time but distributors don't always want to purchase that much product at a time. Quite often a distributor makes a purchase that only fills part of a truck and must wait up to weeks until enough orders come in to fill it up before it is disbursed for delivery.

Solution: Large Suppliers manage and facilitate their distributor sales through the new chemical distribution network. They list product as full truck load on the exchange but it allows distributors to purchase smaller than full truck load amounts. For example BigChemCo lists a truckload of isopropyl Alcohol. A full truckload would consist of 20 pallets. Distributor A comes on the new chemical distribution network and sees that the IPA is available by either purchasing an entire truckload or via consolidated shipment in groups of 5.

Distributor A purchases 15 pallets of IPA so 15 of the 20 have been bought which leaves 5 remaining for a full truck. Distributor 8 (and all other Distributors on the new chemical distribution network) can now view this as a 5 pallet possible purchase directly from BigChemCo. They make that buy and now the truck is ready to be sent out.

Logistics. The shipping logistics are facilitated through Globaltranz. Once the 15 pallets and 5 pallets are purchased to create a FTL then Bill of Ladings documents are sent from the new chemical distribution network to Globaltranz telling GT to pick up an FTL from BigChemCo and split the shipment afterwards to Company A and Company B to their separate locations. Company A and B are each charged LTL rates.

BigChemCo/Large Suppliers: Companies such as BigChemCo do not want to waste their time with shipments that are not Full Truck Loads. This allows them to stick with that but receive smaller orders without the hassle. Everything is managed for them and they receive one single payment for the full truckload.

Distributors: This is a major issue for them as well. They don't want to have to get stuck ordering full truck loads just to buy directly from BigChemCo. They also don't want to have to wait three weeks to wait for a truck to fill up to get the product to their customer. This solves both issues for them.

The new chemical distribution network creates a solution for a huge pain point for the top suppliers and motivation for them to become a part of the exchange. Once the new chemical distribution network starts making points off of manufacturer's products then that is when the $5T total pie starts coming into play instead of the $40B domestic distributor market.

Additional Logistics: To create a full truck the purchase doesn't necessarily need to be the same product. It just needs to be coming from the same location and have the same hazardous standards met by the truck. In the same scenario before Company A could buy 15 pallets of IPA and Company B could buy 5 pallets of Benzene Alcohol as long as the truck was able to ship both types of product and it was coming from the same warehouse.

Inventory and Warehouses: the new chemical distribution network will optionally work with the BigChemCo's to designate what products are produced at what locations so buyers would know what products could be paired together for a consolidated shipment. We would also designate splits and minimum orders. Lastly we would set what each shipment type weighed and how many could fit on an FTL

Payment: Back to the original example Company A's buy costs $7,500 and Company B Costs $2,500. The fee is 3%, the new chemical distribution network takes the ACH from the two company, pulls out the 3% from each, and sends BigChemCo a single payment of $970 ($1,000-3%).

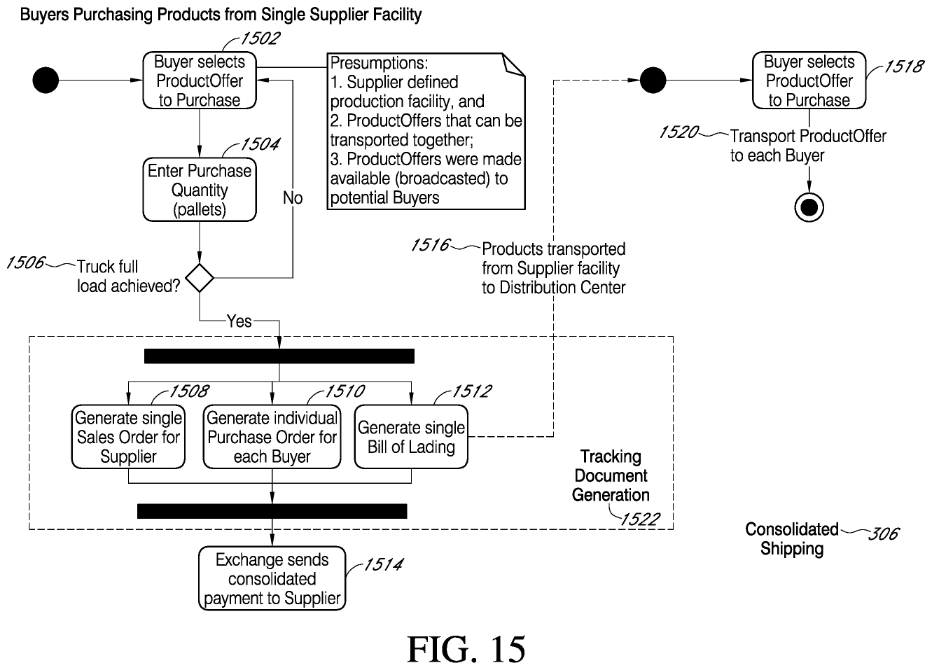

FIG. 15 is a process flow diagram showing a first example of consolidated shipping. Consolidated shipping allows multiple buyers to purchase products from a single supplier facility. First a buyer selects a product offer to purchase 1502, with the following presumptions: 1) supplier defined production facility, 2) product offers that can be transported together, 3) product offers were made available (broadcasted) to potential buyers. Next a purchase quantity is entered (pallets) 1505. If a full transport load is not achieved then the process returns to block 1502 to repeat. If a full load is achieved three items 1508, 1510, and 1512 are checked in parallel in the tracking documents generation block 1522. First a single sales order for the supplier may be generated 1508, second an individual purchase order for each buyer may be generated 1510, and third a single bill of lading may be generated 1512. These generations 1508, 1510, 1512 may typically include a hard copy physical print out on paper, thermal paper, adhesive backed paper, or the like. Including loading the information on a PDA, tablet or other portable device.

Next the Exchange sends consolidated payment to the supplier 1514. Returning to the tracking document block 1522, products are transported form supplier facility to the distribution center 1516. Next an individual bill of lading may be generated for each buyer 1518, and at 1520 the transport product offer to each buyer is performed.

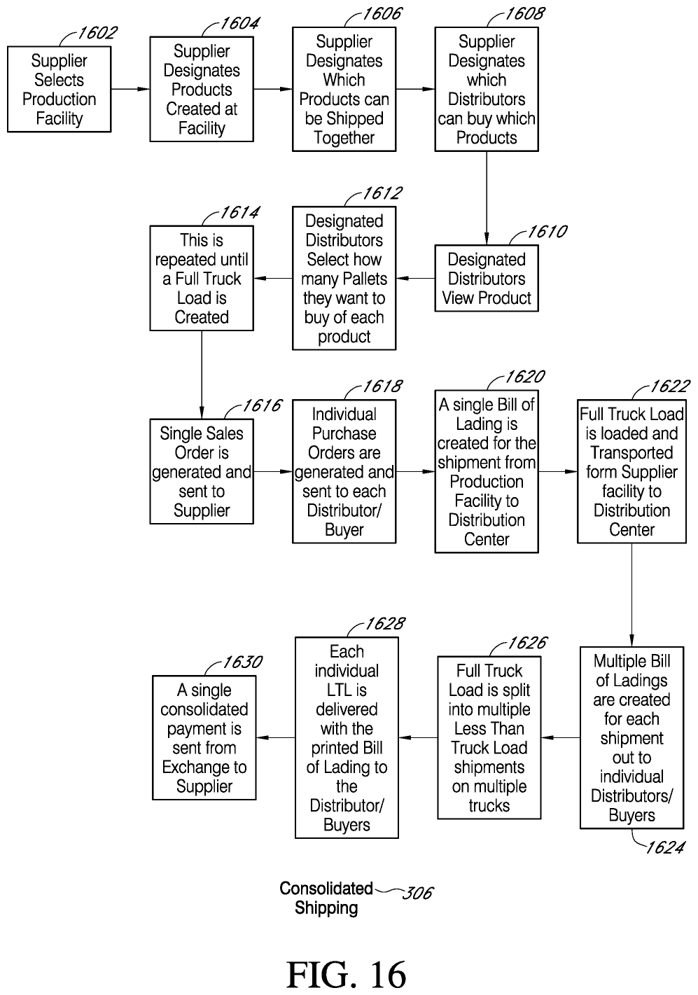

FIG. 16 is a process flow diagram showing a second example of consolidated shipping. A supplier selects a production facility 1602. A supplier next designates products created at the facility 1604. Then a supplier designates which products can be shipped together 1608. Designated distributors then view products 1610. Designated distributors select how many pallets they want to buy of each product 1612. The preceding step is repeated until a full truck load is created 1614. A single sales order is generated and sent to the supplier 1616. Individual purchase orders are generated and sent to each distributor/buyer 1618. A single bill of lading may be created for the shipment from production facility to the distribution center 1620. A full truck (or as full as desired) Is loaded and transported from the supplier facility to the Exchange distribution center 1622. Multiple bills of lading may be created for each shipment out to individual distributors/buyers 1624. The full truck load is split into multiple less than truck load shipments on multiple trucks 1626. Each individual LTL is delivered with the printed bill of lading to the distributor/buyer 1628. And finally a single consolidated payment may be sent from the Exchange to the supplier 1630.

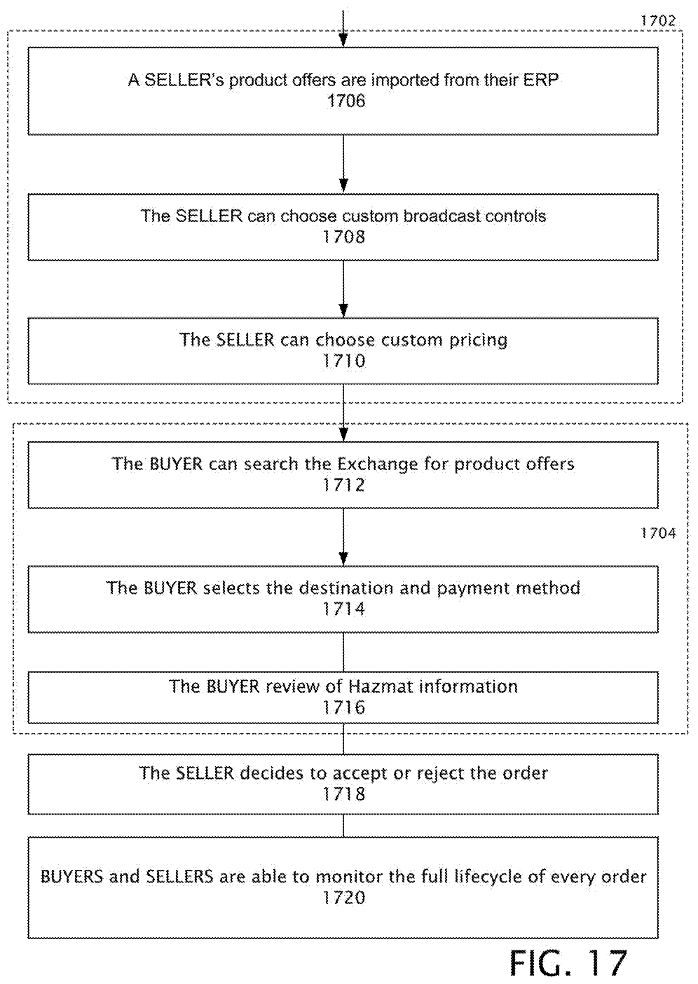

FIG. 17 is a flow diagram showing a process of setting up and using the new web-based chemical exchange. In general the overall exchange functions utilizing seller information 1702, and buyer, or purchaser information 1704 to facilitate the efficient sale of chemical substances.

A seller links to the exchange and sets up their account and product offerings 1706. The seller next is able to utilize the custom broadcast controls 1708. In particular the seller can also set up custom pricing 1710, if desired.

A buyer may search the exchange for product offers 1712. Alternatively, a seller may scan the Exchange and send offers to potential buyers. After a purchase or purchases are made by the buyer a destination and payment method may be set 1714. THE buyer may also review the hazmat information 1716. THE seller has the ability to finally decide if he will accept or reject the order 1718. And finally the exchange may be used by buyers and sellers to monitor the order throughout the process 1720.

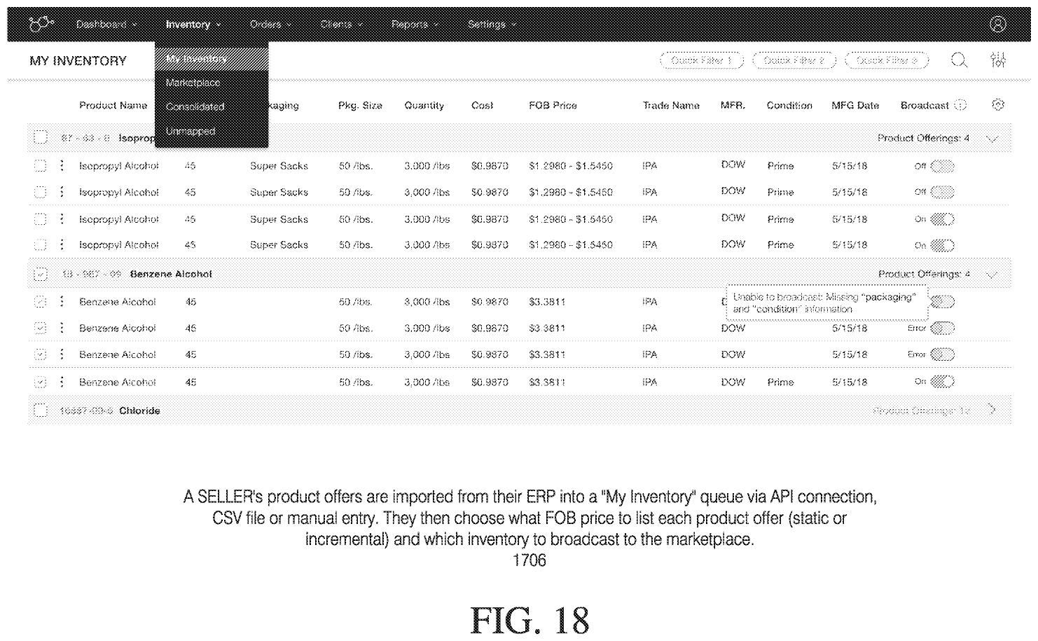

FIG. 18 is a screen shot showing a seller's importation of product offerings on the new web-based chemical exchange. A SELLER's product offers are imported from their ERP into a “My inventory” queue via API connection, CSV file or manual entry. They then choose what FOB price to list each product offer (static or incremental) and which inventory to broadcast to the marketplace 1706.

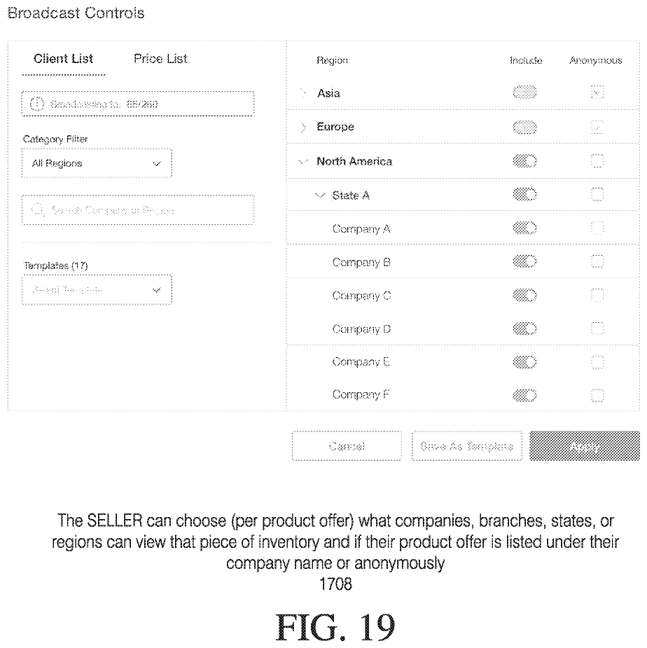

FIG. 19 is a screen shot showing a seller's set up of product offering conditions on the new web-based chemical exchange 1708. The SELLER can choose (per product offer) what companies, branches, states, or regions can view that piece of inventory and if their product offer is listed under their company name or anonymously.

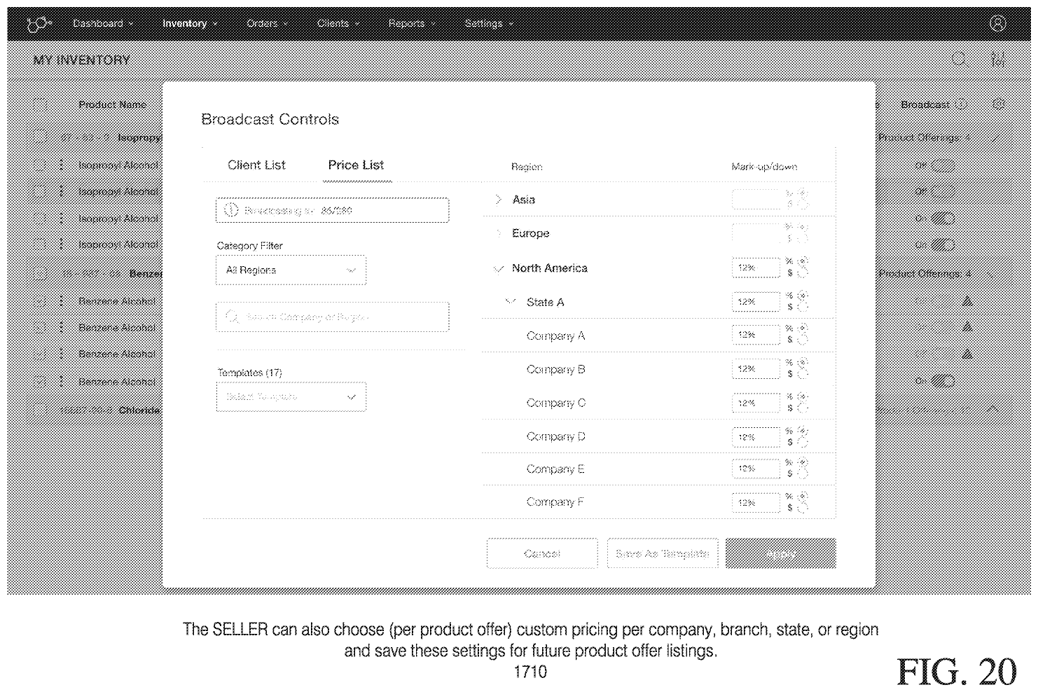

FIG. 20 is a screen shot showing a seller's set up of product pricing on the new web-based chemical exchange. The SELLER can also choose (per product offer) custom pricing per company, branch, state, or region and save these settings for future product offer listings 1710.

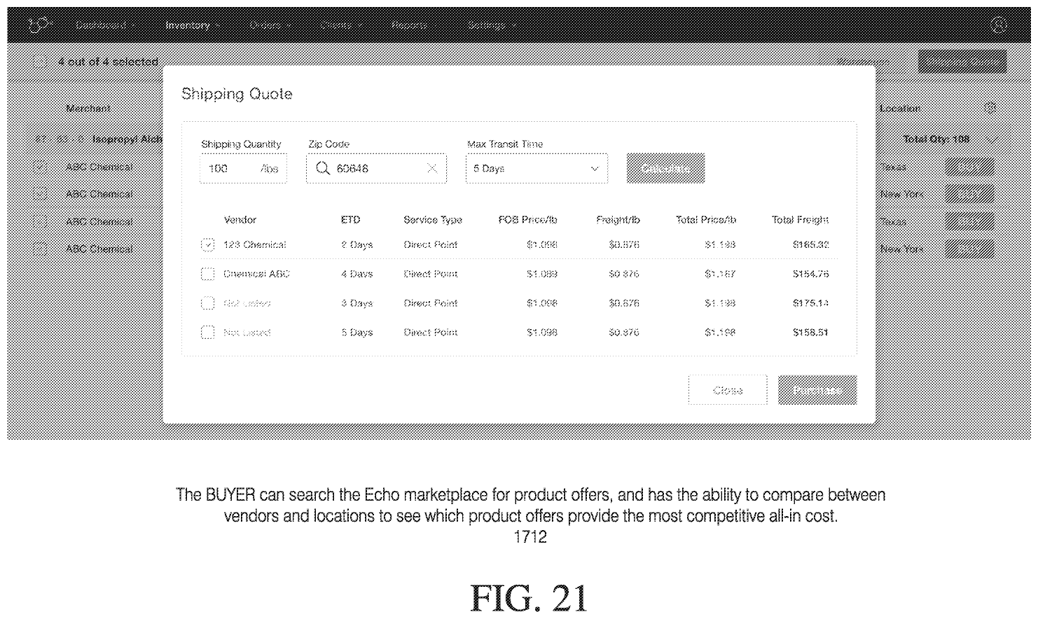

FIG. 21 is a screen shot showing a buyer's results of searching the new web-based chemical exchange. The BUYER can search the Exchange marketplace for product offers, and has the ability to compare between vendors and locations to see which product offers provide the most competitive all-in cost 1712.

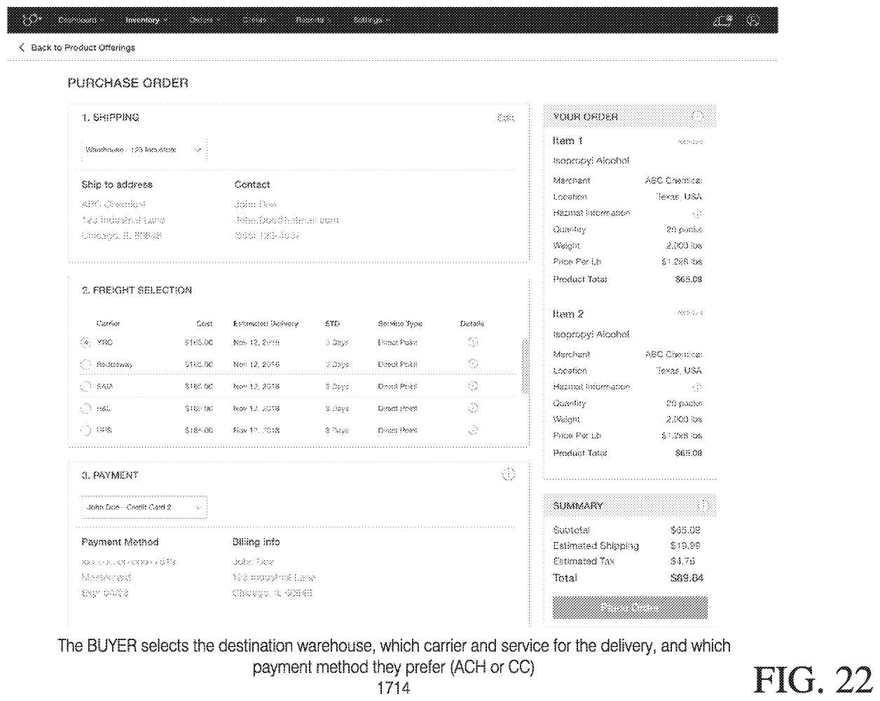

FIG. 22 is a screen shot showing a buyer' completion of product selection on the new web-based chemical exchange. The BUYER selects the destination warehouse, which carrier and service for the delivery, and which payment method they prefer (ACH or CC) 1714.

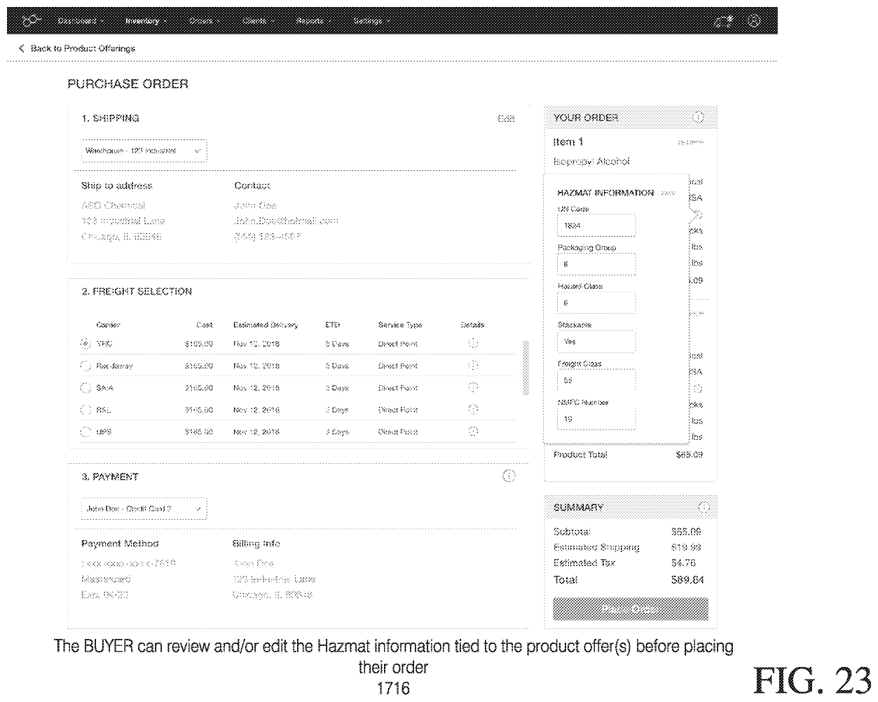

FIG. 23 is a screen shot showing a buyer's review of hazmat information. The BUYER can review and/or edit the Hazmat information tied to the product offer(s) before placing their order 1716.

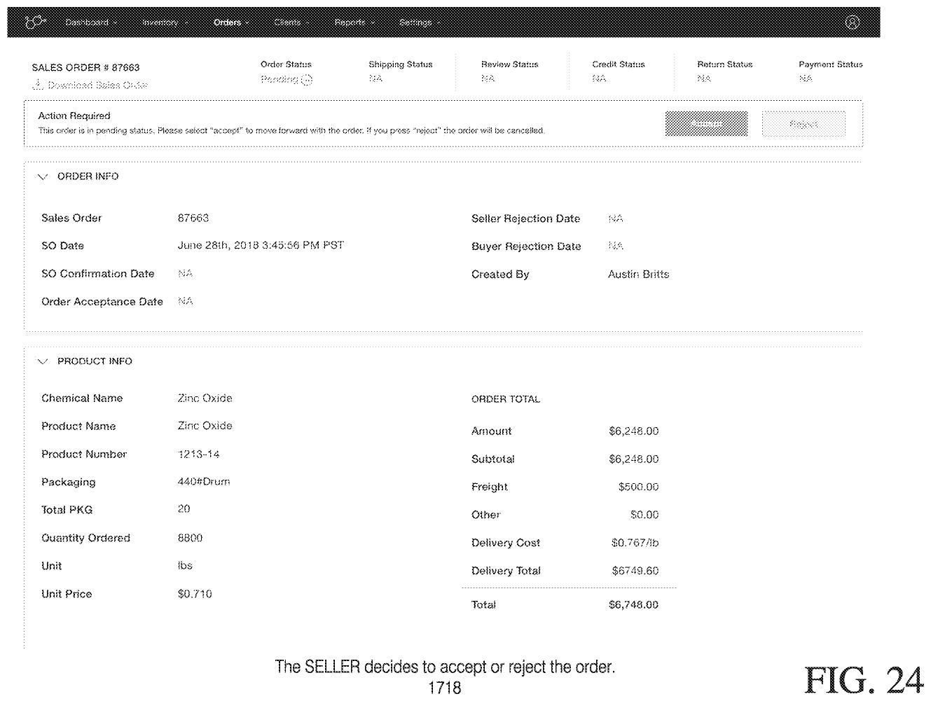

FIG. 24 is a screen shot showing a buyer' final review of a product order on the new web-based chemical exchange. The SELLER decides to accept or reject the order 1718.

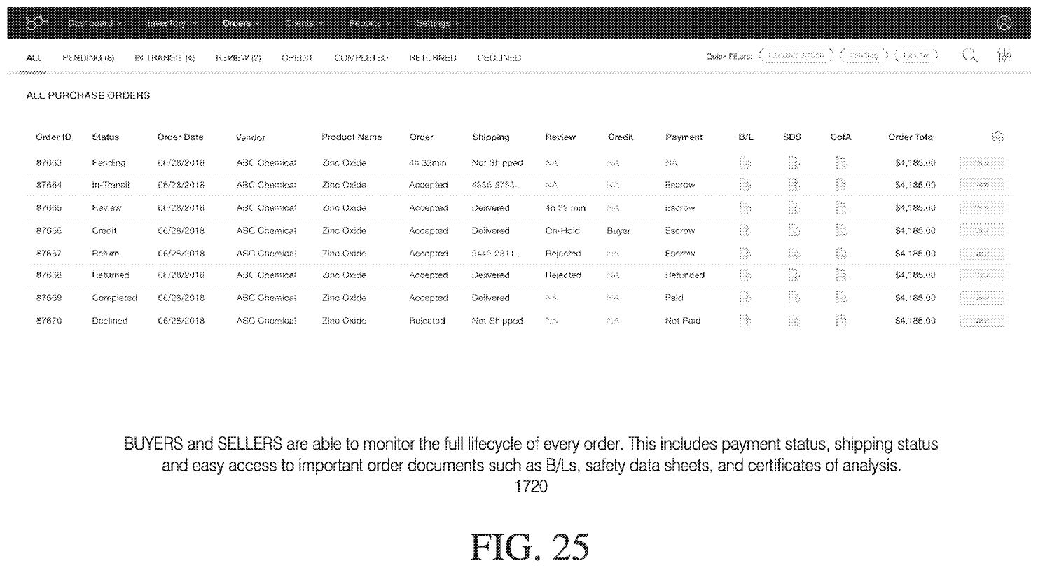

FIG. 25 is a screen shot showing a buyer' completion of a product order on the new web-based chemical exchange. BUYERS and SELLERS are able to monitor the full lifecycle of every order. This includes payment status, shipping status and easy access to important order documents such as B/Is, safety data sheets, and certificates of analysis 1720.

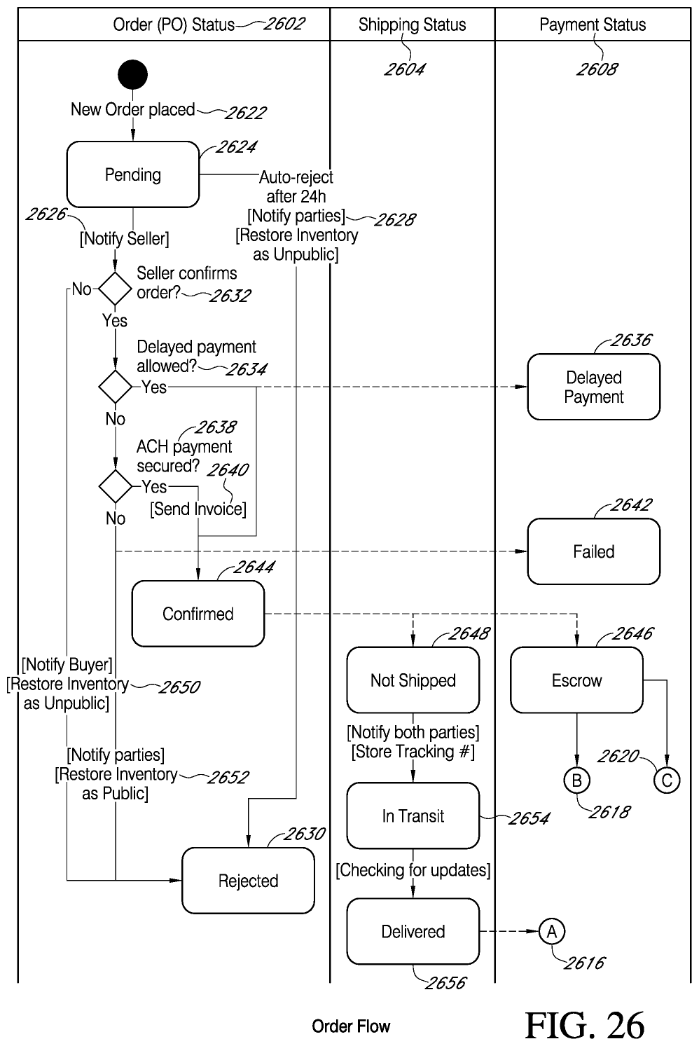

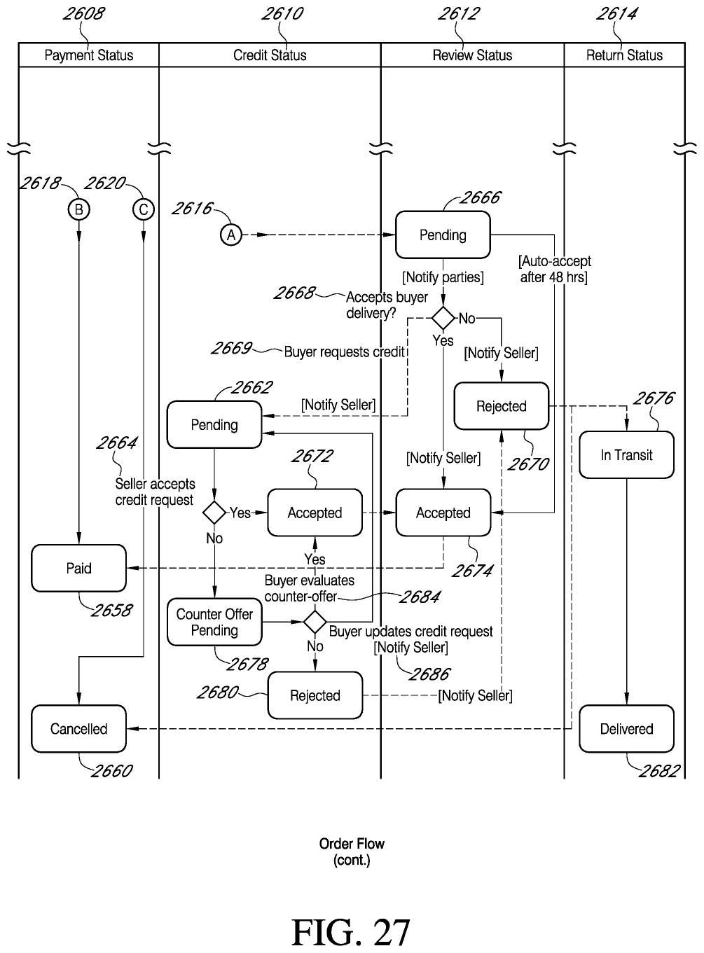

FIGS. 26 and 27 are a process flow diagram showing an example of order flow. The statuses of the order are shown at the top of the figures. The statuses being Order (PO) status 2602, shipping status 2604, payment status 2608, credit status 2610, review status 2612, and return status 2614. The process blocks of the diagram are mapped against the abovementioned statuses as the order progresses through the Exchange.

First a new order is placed 2622. The order now has pending status 2624, and the seller is notified 2626. Alternatively there may be auto rejection after the twenty fourth (or equivalent), where the parties are notified and inventory is restored as unbilled 2628 which turn into a rejected order status 2630. Returning to decision point 2636 the seller may confirm the order. At the next decision point as the order progresses it is determined if delayed payment is allowed, and then if ACH payment is secured 2638 then the order is confirmed 2644. If the decision point 2632 answer is no then the order is rejected 2630, with the buyer being notified, and the inventory being restored as un-public 2650. Likewise if the ACH payment is not secured then the order is rejected 2630 with the parties being notified and the inventory being restored as public 2652.

Returning to block 2634 if delayed payment is allowed then payment is delayed 2636 under payment status. Also returning to 2638 if ACH payment is not secured the payment status is marked failed 2642. If the ACH payment is secured, an invoice is sent 2640, and the order is confirmed 2644. THE nest steps are to record a shipping status 2604 of not shipped 2648 and to set a payment status 2606, of being in escrow 2646. Branches “B” 2618, and “C” 2620 continue on to FIG. 27. Also after recording the shipment as not shipped 2648, with notification to both parties and storing the tracking number the shipment is in transit 2654, and with checking for updates, is delivered 2656, where to flow marked “A” 2616 then progresses to FIG. 27.

Flow B 2618 progressed to paid status 2658. Flow “C” 2620 progresses to canceled status 2660. Order status “A” 2616 progresses to pending status 2666, which after party notification the buyer may accept delivery 2668. If no the seller is notified and delivery is rejected 2670. If accepted at 2668 the order is accepted at 2670. Returning to block 2668 the order may be auto accepted after an exemplary 48 hours where the order proceeds to acceptance 2674.

Also at block 2668 the buyer may request credit 2669 which marks the order pending 2662, then if the seller accepts the credit request the order is accepted 2672 with notification to the seller that the order is accepted 2674 and is then paid 2658. If the seller does not accept the credit request a counter offer may be pending 2678, which the buyer evaluates 2684. If accepted the order is accepted 2672, if not the order is rejected 2680, and the seller is notified of the rejection 2670. Returning to block 2670 if the order is in transit 2676 it may be delivered 2682.

Exemplary Network Upon which the Exchange May Reside

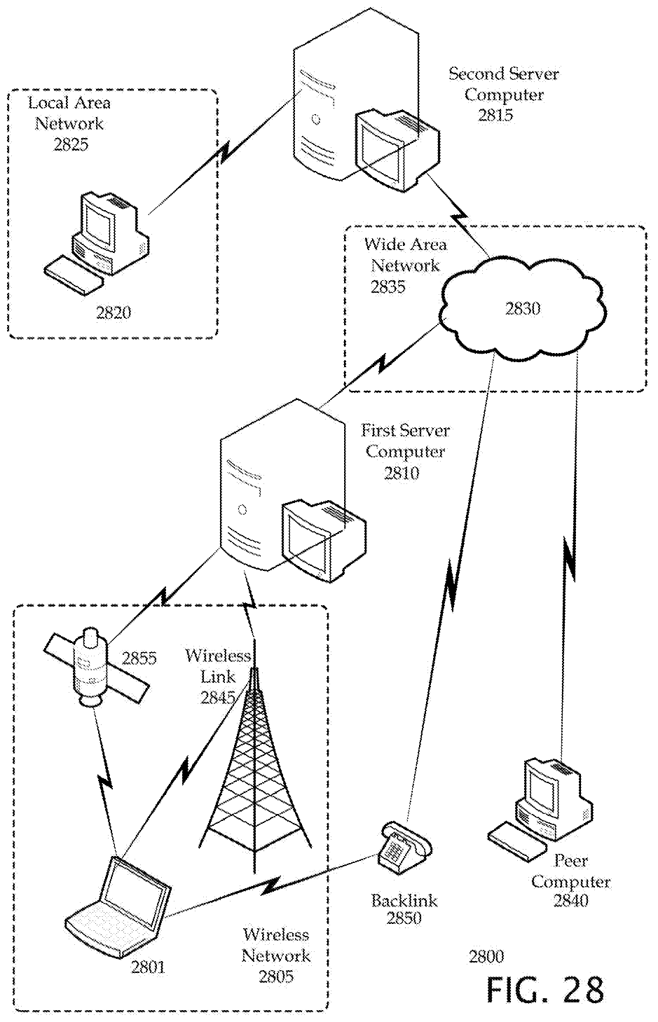

FIG. 28 is an example of a computer network system upon which the new chemical distribution network (“Exchange”) may be implemented. Computer 2815 may be a server computer coupled to a user's computer 2820 through a conventionally constructed local area network 2825.

In the local area network the user's computer is typically part of the local area network 2825 which may include a plurality conventional computers (not shown) and conventional peripheral equipment (not shown) coupled together utilizing topologies (token, star and the like) and switching equipment known to those skilled in the art. Those skilled in the art will realize that other processor equipped devices such as cellular telephones, PDAs, tablets printers, appliances and the like may be coupled to the internet utilizing conventional techniques known to those skilled in the art.

A typical local area network 2825 may include a conventionally constructed ISP network in which a number or plurality of subscribers utilize telephone dial up, ISDN, DSL, cellular telephone, cable modem, or the like connections to couple their computer to one or more server computers 2815 that provide a connection to the world wide web 2835 via the internet 2830.

Wide area network or world wide web 2835 is conventionally constructed and may include the internet 2830 or equivalent coupling methods for providing a wide area network. As shown a conventionally constructed first server computer 2810 is coupled to conventionally constructed second server computer 2815 through a conventionally constructed internet connection to the world wide web 2830.

in a peer to peer network a Peer computer 2840 is conventionally constructed to couple to the internet 2830 utilizing peer to peer network technology. Peer computer 2840 may couple to a plurality of similarly connected peer computers in a peer to peer network (not shown), or to other computers 2801, 2820 that are part of conventionally constructed networks 2825, 2835.

In a conventional wireless network 2805 a conventionally constructed computer 2801 is coupled to the internet 2830 via a conventionally constructed wireless link 2845. The wireless link may include cellular, and satellite technology 2855 to provide the link. Such a wireless network may include a conventionally constructed first server computer 2810, typically provided to manage connections to a wide area network such as the Internet.

A conventionally constructed back link may be provided to efficiently provide an additional channel to couple to the internet. For example in situations where communication is one way in nature, the back link may provide communications in the opposite direction. Those skilled in the art will realize that back links may equivalently be provided by cellular telephones, tablets, cordless telephones, paging devices and the like.

Exemplary Computing Device

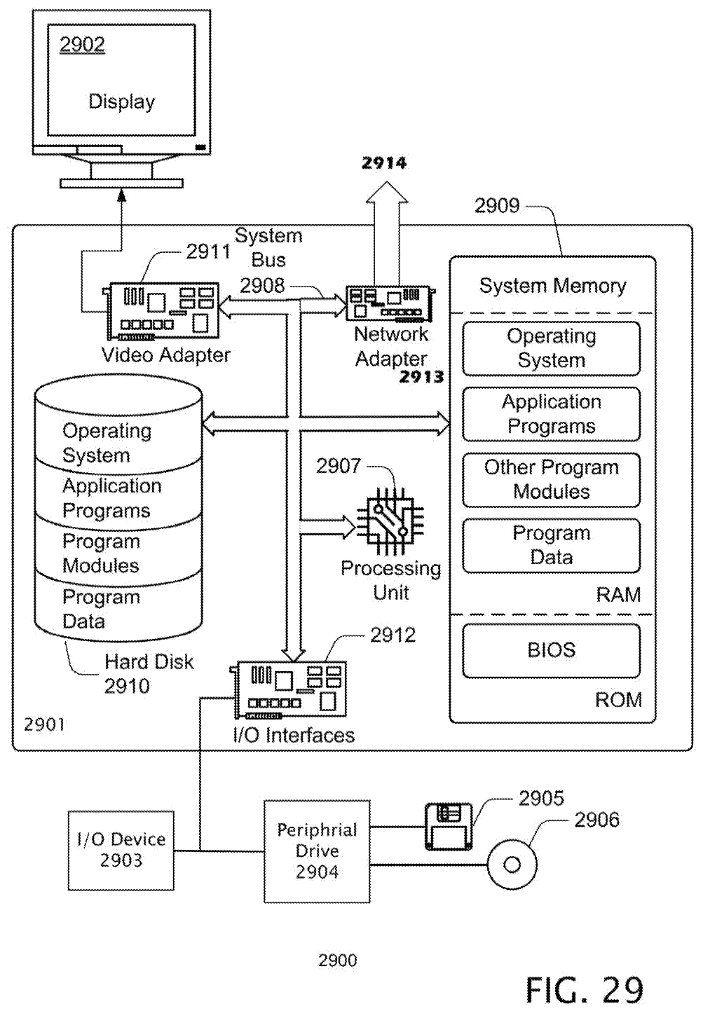

FIG. 29 is an example of a computing system upon which the new chemical distribution network may be implemented. Exemplary computing environment 2900 is only one example of a computing system and is not intended to limit the examples described in this application to this particular computing environment.

For example the computing environment 2900 can be implemented with numerous other general purpose or special purpose computing system configurations. Examples of well known computing systems, may include, but are not limited to, personal computers, hand-held or laptop devices, tablets, microprocessor-based systems, multiprocessor systems, cellular telephones, PDAs, and the like.

The computer 2900 includes a general-purpose computing system in the form of a computing device 2901. The components of computing device 2901 can include one or more processors (including CPUs, GPUs, microprocessors and the like) 2907, a system memory 2909, and a system bus 2908 that couples the various system components. Processor 2907 processes various computer executable instructions, Including those to implement the Exchange and to control the operation of computing device 2901 and to communicate with other electronic and computing devices (not shown). The system bus 2908 represents any number of several types of bus structures, including a memory bus or memory controller, a peripheral bus, an accelerated graphics port, and a processor or local bus using any of a variety of bus architectures.

The system memory 2909 includes computer-readable media in the form of volatile memory, such as random access memory (RAM), and/or non-volatile memory, such as read only memory (ROM). A basic input/output system (BIOS) is stored in ROM. RAM typically contains data and/or program modules that are immediately accessible to and/or presently operated on by one or more of the processors 2907.

Mass storage devices 2904 may be coupled to the computing device 2901 or incorporated into the computing device by coupling to the buss. Such mass storage devices 2904 may include a magnetic disk drive which reads from and writes to a removable, non-volatile magnetic disk (e.g., a “floppy disk”) 2905, or an optical disk drive that reads from and/or writes to a removable, non-volatile optical disk such as a CO-ROM or the like 2906. Computer readable media 2905, 2906 typically embody computer readable instructions, data structures, program modules and the like supplied on floppy disks, CDs, portable memory sticks and the like.

Any number of program modules can be stored on the hard disk 2910. Mass storage device 2904, ROM and/or RAM 2909, including by way of example, an operating system, one or more application programs, other program modules, and program data. Each of such operating system, application programs, other program modules and program data (or some combination thereof) may include an embodiment of the systems and methods described herein.

A display device 2902 can be connected to the system bus 2908 via an interface, such as a video adapter 2911. A user can interface with computing device via any number of different input devices 2903 such as a keyboard, pointing device, joystick, game pad, serial port, and/or the like. These and other input devices are connected to the processors 2907 via input/output interfaces 2912 that are coupled to the system bus 2908, but may be connected by other interface and bus structures, such as a parallel port, game port, and/or a universal serial bus (USB).

Computing device 2900 can operate in a networked environment using connections to one or more remote computers through one or more local area networks (LANs), wide area networks (WANs) and the like. The computing device 2901 is connected to a network 2914 via a network adapter 2913 or alternatively by a modem, DSL, ISDN interface or the like.

The functionalities described herein are not envisioned to be tied to any one communication protocol, programming language or the like, and may be implemented in any convenient form of coding, computer language or the like where called for to implement a particular function in the Exchange.

To aid in providing transaction security it is contemplated that any number of security systems may be employed to protect the integrity of transactions and those using the exchange.

Those skilled in the art will realize that the process sequences described above may be equivalently performed in any order to achieve a desired result. Also, sub-processes may typically be omitted as desired without taking away from the overall functionality of the processes described above.

Those skilled in the art will realize that storage devices utilized to store program instructions can be distributed across a network. For example a remote computer may store an example of the process described as software. A local or terminal computer may access the remote computer and download a part or all of the software to run the program. Alternatively the local computer may download pieces of the software as needed, or distributively process by executing some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

1. (canceled)

2. (canceled)

1. A method for arranging chemical transactions comprising:
receiving one or more files comprised of product data from a seller;
receiving one or more files comprised of customized product offering data from a seller;
receiving one or more files comprised of customized product pricing data from a seller;
transmitting to a buyer one or more product offers based on customized buyer data from the buyer and the customized product offering data, customized product pricing data, and product data from the seller;
receiving instructions from the buyer indicating a destination and a payment method;
transmitting to the buyer hazmat information related to the product offers;
receiving a purchase order containing a request to purchase one or more products from the buyer and transmitting the purchase order to the seller;
receiving instructions from the seller confirming acceptance or rejection of the purchase order; and
transmitting to the buyer and seller the status of the one or more products requested in the purchase order at any time.

2. The method of claim 1, wherein the method is implemented through a global communication network.

3. The method of claim 2, wherein the method further comprises excluding certain product offers from being transmitted to the buyer based on the customized product offering data provided by the seller.

4. The method of claim 1, wherein the method further comprises transmitting to the buyer data detailing unused space on one or more transport vehicles where the unused space is sufficient to accommodate one or more of the products contained in the purchase order.

5. The method of claim 4, wherein the method further comprises allocating the one or more products to the one or more transport vehicles based on availability of the unused space, the distance the one or more transport vehicles would need to travel to reach the buyer, and on how many stops the one or more transport vehicles would need to make before reaching the buyer on a route.

6. The method of claim 4, wherein the method further comprises receiving instructions from the buyer regarding allocating the one or more products contained in the purchase order onto the unused space on one or more transport vehicles and transmitting said instructions to the buyer.

7. The method of claim 2, wherein the method further comprises comparing the product data provided by the seller to a database of chemical names.

8. The method of claim 7 wherein the method further comprises altering one or more product names in the product data provided by the seller based on the comparison of the product data to the database of chemical names to create one or more alternate product names.

9. The method of claim 8 wherein the method further comprises transmitting the one or more alternate product names with the product offers.

10. The method of claim 4, wherein the method further comprises automatically allocating one or more of the products contained in the purchase order onto one or more transport vehicles based on which of the one or more transport vehicles will be able to deliver the one or more products faster than any other of the one or more transport vehicles.

11. The method of claim 3, wherein the seller is able to exclude certain product offers from being transmitted to one or more of the buyers based on at least one of the list comprising: a location of the buyer, a credit rating of the buyer, or a preference against the buyer.

12. A system for arranging chemical transactions comprising:
a memory configured to store a plurality of modules, each module including a plurality of instructions;
a processor coupled to the memory for executing the plurality of instructions of the plurality of modules, the modules comprising:
a product data module configured to receive, compute, and transmit data to other modules based on product data, customized product offering data, and customized product pricing data provided by a seller;
a buyer display module configured to display to one or more buyers the available products from the sellers based on information received from the product data module;
a purchase module configured to receive a purchase order for one or more products from the buyer and transmit it to the seller and then transmit acceptance or rejection of the purchase order from the seller to the buyer;
a tracking module configured to receive and transmit information about the status of the one or more products contained in the purchase order.

13. A computer-readable media comprising non-volatile storage with instructions thereon that, when executed by a processor, performs a method of arranging chemical transactions comprising:
receiving one or more files comprised of product data from a seller;
receiving one or more files comprised of customized product offering data from a seller;
receiving one or more files comprised of customized product pricing data from a seller;
transmitting to a buyer one or more product offers based on customized buyer data from the buyer and the customized product offering data, customized product pricing data, and product data from the seller;
receiving instructions from the buyer indicating a destination and a payment method;
transmitting to the buyer hazmat information related to the product offers;
receiving a purchase order containing a request to purchase one or more products from the buyer and transmitting the purchase order to the seller;
receiving instructions from the seller confirming acceptance or rejection of the purchase order; and
transmitting to the buyer and seller the status of the one or more products requested in the purchase order at any time.

14. The method of claim 7 wherein the method further comprises altering one or more product names in the product data provided by the seller based on the comparison of the product data to the database of chemical names to create one or more alternate product names, wherein the one or more alternate product names are determined using a hierarchal determination based on a preset hierarchy within the database of chemical names.

15. The method of claim 1, wherein the receiving one or more files is carried out via a FTP to automatically pulls .csv file on a timed schedule to communicate inventory and pricing change.
